(19) United States
(12) Patent Application Publication
(10) Pub. No.: US 2026/0259722 A1
(43) Pub. Date: Sep. 3, 2026

(54) GENERATION OF MULTI-STAGE CONTAINER IMAGES USING ARTIFICIAL INTELLIGENCE

(71) Applicant: International Business Machines Corporation, Armonk, NY (US)

(72) Inventors: Yu Zui You, Ningbo (CN); Zhan Peng Huo, Beijing (CN); Heng Wang, Beijing (CN); Xiao Ling Chen, Beijing (CN)

(21) Appl. No.: 19/068,033

(22) Filed: Mar. 3, 2025

(51) Int. Cl. G06F 8/61; G06F 11/3604

(52) U.S. Cl. CPC G06F 8/63; G06F 11/3604

(57) ABSTRACT

Generation of multi-stage container images using Artificial Intelligence (AI) is provided and includes retrieving a first input that includes a set of instructions associated with an application. A set of build stages is generated based on the first input and a first set of errors associated with a first subset of instructions of the set of instructions are identified. The first subset of instructions is associated with a first build stage of the set of build stages. An AI model is applied to the first set of errors and the first set of errors is resolved based on the application of the AI model to the first set of errors. Based on the resolution of the first set of errors a first portion of a container image is generated and outputted.

### BACKGROUND

The disclosure relates to containerization and more particularly, to container images.

In recent years, there has been a notable shift from traditional monolithic applications, which typically operate on virtual or physical servers, to microservices architectures that leverage containers. The evolution is driven by the need for enhanced flexibility, scalability, and efficiency in software development processes. Containerization technologies have become critical tools in the transformation, enabling developers to package applications and the dependencies into isolated environments known as container images.

Container images are lightweight, standalone, and executable packages that encompass everything critical for running a piece of software, including application code, runtime, libraries, environment variables, and configuration files. The container images are transforming the landscape of software development and deployment by enabling organizations to deploy new features and fixes rapidly, thereby significantly improving the time-to-market. The application of containerization technologies extends beyond mere software development; they also enhance operational efficiency and resource utilization. By encapsulating applications in containers, organizations achieve greater consistency across different environments, from development to production. The consistency across different environments reduces the likelihood of environment-related issues and simplifies the deployment process. Moreover, the advent of multi-stage container images has further optimized the process by allowing developers to build images in multiple independent stages. These multi-stage container images not only reduce the final image size but also improve performance by ensuring that only the critical components are included in the final product.

### SUMMARY

In various embodiments of the disclosure, a computer-implemented method for generation of a multi-stage container image using artificial intelligence (AI) is described. The computer-implemented method includes retrieving, by a computer, a first input that includes a set of instructions associated with the application. The computer-implemented method further includes generating, by the computer, a set of build stages based on the first input. Each build stage of the set of build stages includes a corresponding subset of instructions of the set of instructions. The computer-implemented method further includes identifying, by the computer, a first set of errors associated with a first subset of instructions of the set of instructions. The first subset of instructions is associated with a first build stage of the set of build stages. The computer-implemented method further includes applying, by the computer, an Artificial Intelligence (AI) model to the first set of errors. The computer-implemented method further includes resolving, by the computer, the first set of errors based on the application of the AI model to the first set of errors. The computer-implemented method further includes generating, by the computer, a first portion of a container image based on the resolution of the first set of errors. The computer-implemented method further includes outputting, by the computer, the first portion of the container image.

In various embodiments of the disclosure, a computer system for generation of a multi-stage container image using artificial intelligence (AI) is described. The computer system includes a processor set, one or more computer-readable storage media, and program instructions stored on the one or more computer-readable storage media. The program instructions are executable by the processor set and cause the processor set to retrieve a first input that includes a set of instructions associated with an application. The program instructions further cause the processor set to generate a set of build stages based on the first input. Each build stage of the set of build stages includes a corresponding subset of instructions of the set of instructions. The program instructions further cause the processor set to identify a first set of errors associated with a first subset of instructions of the set of instructions. The first subset of instructions is associated with a first build stage of the set of build stages. The program instructions further cause the processor set to apply an Artificial Intelligence (AI) model to the first set of errors. The program instructions further cause the processor set to resolve the first set of errors based on the application of the AI model to the first set of errors. The program instructions further cause the processor set to generate a first portion of a container image based on the resolution of the first set of errors. The program instructions further cause the processor set to generate a second portion of the container image based on the generated first portion. The program instructions further cause the processor set to output the first portion and the second portion of the container image.

In various embodiments of the disclosure, a computer-program product for generation of a multi-stage container image using artificial intelligence (AI) is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF DRAWINGS

The following description will provide details of preferred embodiments with reference to the following figures, wherein:

FIG. 1 is a diagram that illustrates a computing environment for generation of a multi-stage container image using Artificial Intelligence (AI), in accordance with an embodiment of the disclosure;

FIG. 2 is a diagram that illustrates an environment for generation of a multi-stage container image using artificial intelligence (AI), in accordance with an embodiment of the disclosure;

FIG. 3 is a diagram that illustrates first exemplary operations for generation of a multi-stage container image using artificial intelligence (AI), in accordance with an embodiment of the disclosure;

FIG. 4 is a diagram that illustrates second exemplary operations for generation of a multi-stage container image using artificial intelligence (AI), in accordance with an embodiment of the disclosure;

FIG. 5 is a diagram that illustrates third exemplary operations for generation of a multi-stage container image using artificial intelligence (AI), in accordance with an embodiment of the disclosure;

FIG. 6 is a diagram that illustrates exemplary operations for training an artificial intelligence (AI) model for generation of a multi-stage container image, in accordance with an embodiment of the disclosure;

FIG. 7A is a diagram that illustrates an exemplary first user interface for generation of a multi-stage container image using artificial intelligence (AI), in accordance with an embodiment of the disclosure;

FIG. 7B is a diagram that illustrates an exemplary second user interface for generation of a multi-stage container image using artificial intelligence (AI), in accordance with an embodiment of the disclosure;

FIG. 8 is a diagram that illustrates a flowchart of a first exemplary method for generation of a multi-stage container image using artificial intelligence (AI), in accordance with an embodiment of the disclosure; and

FIG. 9 is a diagram that illustrates a flowchart of a second exemplary method for generation of a multi-stage container image using artificial intelligence (AI), in accordance with an embodiment of the disclosure.

### DETAILED DESCRIPTION

The rise of container technologies marks a significant shift in software deployment and distribution practices. As organizations increasingly adopt cloud-native and microservices architectures, containerization platforms have emerged as a fundamental tool that manages the packaging and management of applications within containers. The evolution is driven by the need for enhanced flexibility, scalability, and efficiency in software development processes. Containers encapsulate an application and its dependencies, ensuring consistent performance across various environments.

These container technologies have a wide array of applications across different sectors. In software development, containers are utilized to create isolated environments for applications, which helps streamline the development lifecycle. Developers can build, test, and deploy applications consistently across local, staging, and production environments. Additionally, the capabilities of the container technologies extend to continuous integration and continuous deployment (CI/CD) workflows, allowing teams to automate testing and deployment processes effectively. Beyond development, organizations leverage the containers in microservices architectures where applications are divided into smaller, manageable services that can be deployed independently. The modular approach not only enhances scalability but also improves fault isolation and resource utilization.

The advantages of using these container technologies are numerous. The containers are lightweight and can be built and deployed much faster than traditional virtual machines. The rapid deployment capability of container technologies significantly reduces the time from code creation to production release, which is critical in a fast-paced software development environment. Furthermore, applications packaged within containers can be easily moved across different environments (whether on-premises or in the cloud) without compatibility issues. Elimination of the compatibility issues ensures that developers can work in consistent environments regardless of where the code is executed.

The container images are lightweight, standalone, and executable packages that encompass everything critical for running a piece of software, including application code, runtime, libraries, environment variables, and configuration files. They are transforming the landscape of software development and deployment by enabling organizations to deploy new features and fixes rapidly, thereby significantly improving the time-to-market. Moreover, the advent of multi-stage container images has further improved the landscape of software development by allowing developers to build images in multiple independent stages. The multi-stage build approach not only reduces the final image size but also improves performance by ensuring that only the critical components are included in the final product.

The benefits of multi-stage container images extend to the ability to streamline the development process. By separating the build environment from the runtime environment, developers can create smaller images that contain only the artifacts that are critical for execution. The capability of multi-stage container images is particularly advantageous in microservices architectures where lightweight deployments are critical for scalability and resource management. As a result, organizations can respond dynamically to changing workloads and demands while also ensuring that the applications remain consistent and reliable across various environments.

Despite its advantages, the field of container technologies faces several challenges. One prominent issue is the complexity of debugging multi-stage container images. As applications grow more complex, developers often encounter difficulties identifying errors during the build process due to a lack of flexibility in existing debugging tools. Current solutions do not allow for easy separation of build stages or retention of intermediate stages of the multi-stage container images, forcing developers to re-execute the entire build of the multi-stage container images when issues arise.

Moreover, there is a lack of interactivity and visualization in debugging tools associated with these containerization technologies. Most debugging processes rely heavily on command-line interfaces (CLIs) without intuitive visualization options that could simplify understanding of build processes or logs for the developers. The reliance on command lines increases complexity and time costs for developers who must frequently modify commands to troubleshoot issues. Insufficient automation in the build steps of these multi-stage container images is also a significant problem. Existing tools do not provide automated analysis or recommendations for improving build efficiency or reducing image sizes; developers often must rely on their experience.

Traditional methods for generation of multi-stage container images often rely on manual interventions for the detection and resolution of errors that arise during the build process. These manual interventions are time-consuming, cumbersome, and inaccurate in many cases. Furthermore, these traditional methods often rely on rebuilding the entire multi-stage container images when these errors arise. These traditional methods do not allow retention of intermediate stages due to which computing systems have to regenerate the entire multi-stage container images when these errors arise.

Furthermore, these traditional methods rely on developers to search through the entire file (the entire code) for errors and resolve the errors through command-line interfaces (CLIs). Due to these factors, the traditional methods often increase the processing time of the computing systems and the computing resources for performing the generation of multi-stage container images. Therefore, there is a need for an improved solution to the generation of multi-stage container images.

The disclosed system generates the multi-stage container images by independent stage splitting and automated debugging. Using the independent stage splitting, the disclosed system splits the entire build process into multiple build stages and generates the multi-stage container images stage by stage after automatically debugging the errors encountered during the build process of a respective stage. The disclosed system further retains and stores the intermediate stages (generated after the automated debugging) and further utilizes the intermediate stages to generate and debug the successive stages of the multi-stage container images.

The disclosed system utilizes the stored intermediates stages (that are generated after the automated debugging) to generate and debug the successive stages of the multi-stage container images. Hence, in case any errors are identified during the generation of the successive stages, then there is no need for the disclosed system to regenerate the entire multi-stage container image. The disclosed system will have to regenerate only the successive stages and utilize the intermediate stages (since the intermediate stages are already debugged) for the generation of the multi-stage container image. Hence, the disclosed system reduces the processing time of the computing systems and the computing resources for the generation of the multi-stage container images by eliminating the need for the regeneration of the entire multi-stage container image.

The disclosed system further automates the process of identification and the resolution of errors during the build process of the multi-stage container images. Moreover, since the disclosed system performs the generation of the multi-stage container image stage by stage, the disclosed system also reduces the searching space for the identification of the errors. The disclosed system searches and resolves the error in a single build stage for each iteration rather than searching the entire code for the errors. The automation of the resolution of errors further increases the accuracy of the resolution of the errors and reduces the chances of manual errors.

The disclosed system further provides an interactive terminal (or a user-friendly interface) for communication between the users and the generation process of the multi-stage container images. The disclosed system provides information to the users through which the users can identify the errors, verify the correction made by the disclosed system and manually enter the correction in case they find some inaccuracies in the automated corrections generated by the disclosed system.

In various embodiments of the disclosure, a computer-implemented method for generation of a multi-stage container image using artificial intelligence (AI) is described. The computer-implemented method includes retrieving, by a computer, a first input that includes a set of instructions associated with the application. The computer-implemented method further includes generating, by the computer, a set of build stages based on the first input. Each build stage of the set of build stages includes a corresponding subset of instructions of the set of instructions. The computer-implemented method further includes identifying, by the computer, a first set of errors associated with a first subset of instructions of the set of instructions. The first subset of instructions is associated with a first build stage of the set of build stages. The computer-implemented method further includes applying, by the computer, an Artificial Intelligence (AI) model to the first set of errors. The computer-implemented method further includes resolving, by the computer, the first set of errors based on the application of the AI model to the first set of errors. The computer-implemented method further includes generating, by the computer, a first portion of a container image based on the resolution of the first set of errors. The computer-implemented method further includes outputting, by the computer, the first portion of the container image. The disclosed computer-implemented method automates the process of resolution of errors which increases the accuracy in the process of resolution of the errors and reduces the chances of manual errors. The disclosed computer-implemented method further generates the multi-stage container image stage by stage after debugging the errors of the respective stage. Hence, in case any errors are identified in the successive stages of the generation of the multi-stage container image, then there is no need to regenerate the entire container image. Since the need for the regeneration of the entire container image is eliminated, the disclosed computer-implemented method reduces the processing time of the computing systems and the computing resources to generate the multi-stage container images.

In various embodiments of the disclosure, the computer-implemented method further includes executing, by the computer, a second subset of instructions of the set of instructions based on the generated first portion. The second subset of instructions is associated with a second build stage of the set of build stages. The computer-implemented method further includes generating, by the computer, a second portion of the container image based on the execution of the second subset of instructions. The computer-implemented method further includes outputting, by the computer, the second portion of the container image. Since the disclosed computer-implemented method utilizes the generated first portion (that had been already automatically debugged) to generate the second portion, the disclosed computer-implemented method eliminates the possibility of any errors or bugs arising in the second portion due to the first portion (in case the second portion is dependent on the first portion of the container image).

In various embodiments of the disclosure, the computer-implemented method further includes identifying, by the computer, a second set of errors associated with the second subset of instructions. The computer-implemented method further includes applying, by the computer, the AI model to the second set of errors. The computer-implemented method further includes resolving, by the computer, the second set of errors based on the application of the AI model to the second set of errors. The computer-implemented method further includes generating, by the computer, the second portion of the container image based on the resolution of the second set of errors and the generated first portion. In case any error is identified during the generation of the second portion, the disclosed computer-implemented method automatically resolves the errors and regenerates only the second portion without regenerating the first portion again. Since the need for the regeneration of the first portion is eliminated, the disclosed computer-implemented method reduces the processing time of the computing systems and the computing resources for the generation of the multi-stage container image.

In various embodiments of the disclosure, the computer-implemented method further includes generating, by the computer, the container image based on the generated first portion and the generated second portion. The computer-implemented method further includes outputting, by the computer, the container image. Utilization of the generated first portion and the generated second portion (both of which are already automatically debugged) to generate successive portions of the container image eliminates the need for regenerating the first portion and the second portion in case some errors are identified during the generation of the successive portions. Hence, the disclosed computer-implemented method reduces the processing time of the computing systems and the computing resources for the generation of the multi-stage container image by eliminating the need for regeneration of the first portion and the second portion.

In various embodiments of the disclosure, the computer-implemented method further includes modifying, by the computer, the first subset of instructions associated with the first build stage based on the resolution of the first set of errors. The computer-implemented method further includes executing, by the computer, the modified first subset of instructions. The computer-implemented method further includes generating, by the computer, the first portion based on the execution of the modified first subset of instructions. The disclosed computer-implemented method automatically resolves the errors by providing the modified first subset of instructions in which the errors are resolved with accuracy and precision. Hence, the disclosed computer-implemented method reduces the possibility of manual errors and increases the accuracy of the process of resolution of the errors.

In various embodiments of the disclosure, the computer-implemented method further includes retrieving, by the computer, a second input associated with the first set of errors. The computer-implemented method further includes modifying, by the computer, the first subset of instructions based on the second input. The disclosed computer-implemented method further includes retrieving manual corrections in case automated corrections are not accurate. These manual corrections can be utilized to fine-tune the AI model, which in turn increases the accuracy of the AI model for the resolution of the errors.

In various embodiments of the disclosure, the computer-implemented method further includes rendering, by the computer, the first set of errors and the modified first subset of instructions on a user device. The computer-implemented method further includes retrieving, by the computer, the second input from the user device. The disclosed computer-implemented method further provides an interactive terminal (or a user-friendly interface) to obtain the corrected instructions in case the user does not want to proceed with automated corrections. Hence, the disclosed computer-implemented method resolves the problem of lack of interactivity and visualization associated with the traditional methods.

In various embodiments of the disclosure, the computer-implemented method further includes retrieving, by the computer, historical data including a plurality of instructions and a set of errors associated with the plurality of instructions. The plurality of instructions is inclusive of the set of instructions and the set of errors is inclusive of the first set of errors and the second set of errors. The computer-implemented method further includes retrieving, by the computer, a plurality of modified instructions associated with the set of errors. Each modified instruction of the plurality of modified instructions is associated with a resolution of a respective error of the set of errors. The plurality of modified instructions is inclusive of the modified first subset of instructions. The computer-implemented method further includes generating, by the computer, a training dataset based on the plurality of instructions, the set of errors, and the plurality of modified instructions. The computer-implemented method further includes training, by the computer, the AI model based on the training dataset. The training of the AI model enables the automated detection and resolution of the set of errors. The automated detection and the resolution of the set of errors eliminate the possibility of manual errors and increase the accuracy of the process of resolution of the set of errors.

In various embodiments of the disclosure, the computer-implemented method further includes generating, by the computer, one or more breakpoints in the first subset of instructions. The computer-implemented method further includes resolving, by the computer, the first set of errors based on the generated one or more breakpoints. The generated one or more breakpoints are utilized to isolate and examine critical sections of the build process. Pausing the execution at these one or more breakpoints, the disclosed computer-implemented method determines that the critical sections of the set of instructions of the application are functioning correctly before proceeding further. Therefore, the disclosed computer-implemented method increases the accuracy of the resolution of the errors by enabling targeted inspection and troubleshooting.

In various embodiments of the disclosure, the computer-implemented method further includes applying, by the computer, the AI model to the first subset of instructions associated with the first build stage. The computer-implemented method further includes identifying, by the computer, the first set of errors associated with the first build stage based on the application of the AI model to the first subset of instructions. The disclosed computer-implemented method automates the process of identification of the errors. Automating the process of the identification of errors increases the accuracy of the identification of the errors and eliminates the possibility of missing some errors. Moreover, since the disclosed computer-implemented method identifies the errors in a single build stage rather than searching the entire set of instructions, the processing time of the computing system is reduced for the identification of the errors.

In various embodiments of the disclosure, the computer-implemented method further includes applying, by the computer, one or more rules to the first input. The computer-implemented method further includes generating, by the computer, the set of build stages based on the application of the one or more rules to the first input. By generating the set of build stages, the disclosed computer-implemented method performs independent stage splitting to generate and automatically debug the multi-stage container image stage by stage. Generating and debugging the multi-stage container image stage by stage eliminates the need for regeneration of the entire multi-stage container image in case errors are identified in successive stages. Hence, the disclosed computer-implemented method reduces the processing time of the computing systems and the computing resources for the generation of the multi-stage container image by eliminating the need for regeneration of the entire multi-stage container image.

In various embodiments of the disclosure, the computer-implemented method further includes receiving, by the computer, feedback associated with the generated first portion of the container image. The computer-implemented method further includes training, by the computer, the AI model based on the feedback. The feedback can be used to fine-tune the AI model which increases the accuracy of the process of the automated identification and resolution of the errors.

In various embodiments of the disclosure, a computer system for generation of a multi-stage container image using artificial intelligence (AI) is described. The computer system includes a processor set, one or more computer-readable storage media, and program instructions stored on the one or more computer-readable storage media. The program instructions are executable by the processor set and cause the processor set to retrieve a first input that includes a set of instructions associated with an application. The program instructions further cause the processor set to generate a set of build stages based on the first input. Each build stage of the set of build stages includes a corresponding subset of instructions of the set of instructions. The program instructions further cause the processor set to identify a first set of errors associated with a first subset of instructions of the set of instructions. The first subset of instructions is associated with a first build stage of the set of build stages. The program instructions further cause the processor set to apply an Artificial Intelligence (AI) model to the first set of errors. The program instructions further cause the processor set to resolve the first set of errors based on the application of the AI model to the first set of errors. The program instructions further cause the processor set to generate a first portion of a container image based on the resolution of the first set of errors. The program instructions further cause the processor set to generate a second portion of the container image based on the generated first portion. The program instructions further cause the processor set to output the first portion and the second portion of the container image. The disclosed computer system automates the process of resolution of errors which increases the accuracy in process of the resolution of the errors and reduces the chances of manual errors. The disclosed computer system further generates the multi-stage container image stage by stage after debugging the errors of the respective stage. Hence, in case any errors are identified in the successive stages of the generation of the multi-stage container image, then there is no need to regenerate the entire container image. Since the need for the regeneration of the entire container image is eliminated, the disclosed computer system reduces the processing time of the computing systems and the computing resources to generate the multi-stage container images.

In various embodiments of the disclosure, the program instructions further cause the processor set to execute a second subset of instructions of the set of instructions based on the generated first portion. The second subset of instructions is associated with a second build stage of the set of build stages. The program instructions further cause the processor set to generate the second portion of the container image based on the execution of the second subset of instructions. Since the disclosed computer system utilizes the generated first portion (that had been already automatically debugged) to generate the second portion, the disclosed computer system eliminates the possibility of any errors or bugs arising in the second portion due to the first portion (in case the second portion is dependent on the first portion of the container image).

In various embodiments of the disclosure, the program instructions further cause the processor set to identify a second set of errors associated with the second subset of instructions. The program instructions further cause the processor set to apply the AI model to the second set of errors. The program instructions further cause the processor set to resolve the second set of errors based on the application of the AI model to the second set of errors. The program instructions further cause the processor set to generate the second portion of the container image based on the resolution of the second set of errors and the generated first portion. In case any error is identified during the generation of the second portion, the disclosed computer system automatically resolves the errors and generates the second portion without regenerating the first portion again. Since the need for the regeneration of the first portion is eliminated, the disclosed computer system reduces the processing time of the computing systems and the computing resources for the generation of the multi-stage container image.

In various embodiments of the disclosure, the program instructions further cause the processor set to generate the container image based on the generated first portion and the generated second portion. The program instructions further cause the processor set to output the container image. Utilization of the generated first portion and the generated second portion (both of which are already automatically debugged) to generate successive portions of the container image eliminates the need for regenerating the first portion and the second portion again in case some errors are identified during the generation of the successive portions. Therefore, the disclosed computer system reduces the processing time of the computing systems and the computing resources for the generation of the multi-stage container image.

In various embodiments of the disclosure, the program instructions further cause the processor set to modify the first subset of instructions associated with the first build stage based on the resolution of the first set of errors. The program instructions further cause the processor set to execute the modified first subset of instructions. The program instructions further cause the processor set to generate the first portion based on the execution of the modified first subset of instructions. The disclosed computer system automatically resolves the errors by providing the modified first subset of instructions in which the errors are accurately resolved. Hence, the disclosed computer system reduces the possibility of manual errors and increases the accuracy of the process of resolution of the errors.

In various embodiments of the disclosure, the program instructions further cause the processor set to generate one or more breakpoints in the first subset of instructions. The program instructions further cause the processor set to resolve the first set of errors based on the generated one or more breakpoints. The generated one or more breakpoints are utilized to isolate and examine critical sections of the build process. Pausing the execution at these one or more breakpoints, the disclosed computer system determines that critical portions of the set of instructions are functioning correctly before proceeding further. Therefore, the disclosed computer system increases the accuracy of the resolution of the errors by enabling targeted inspection and troubleshooting.

In various embodiments of the disclosure, the program instructions further cause the processor set to apply the AI model to the first subset of instructions associated with the first build stage. The program instructions further cause the processor set to identify the first set of errors associated with the first build stage based on the application of the AI model to the first subset of instructions. The disclosed computer system automates the process of identification of the errors. Automating the process of the identification of the errors reduces increases the accuracy of the identification of the errors, and eliminates the possibility of missing some errors. Moreover, since the disclosed computer system identifies the errors in a single build stage rather than searching the entire set of instructions, the disclosed computer system reduces the processing time of the computing system for the identification of the errors.

In various embodiments of the disclosure, a computer-program product for generation of a multi-stage container image using artificial intelligence (AI) is described. The computer program product includes one or more computer-readable storage media and program instructions stored in the one or more computer-readable storage media to perform operations that include retrieving a first input that includes a set of instructions associated with an application. The operations further include generating a set of build stages based on the first input. Each build stage of the set of build stages includes a corresponding subset of instructions of the set of instructions. The operations further include identifying a first set of errors associated with a first subset of instructions of the set of instructions. The first subset of instructions is associated with a first build stage of the set of build stages. The operations further include applying an Artificial Intelligence (AI) model to the first set of errors. The operations further include resolving the first set of errors based on the application of the AI model to the first set of errors. The operations further include generating a first portion of the container image based on the resolution of the first set of errors. The operations further include outputting the first portion of the container image. The disclosed computer-program product automates the process of resolution of errors which increases the accuracy in the resolution of the errors and reduces the chances of manual errors. The disclosed computer-program product further generates the multi-stage container image stage by stage after debugging the errors of the respective stage. Hence, in case any errors are identified in the successive stages of the generation of the multi-stage container image, then there is no need to regenerate the entire container image. Since the need for the regeneration of entire container image is eliminated the disclosed computer-program product reduces the processing time of the computing systems and the computing resources to generate the multi-stage container images.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

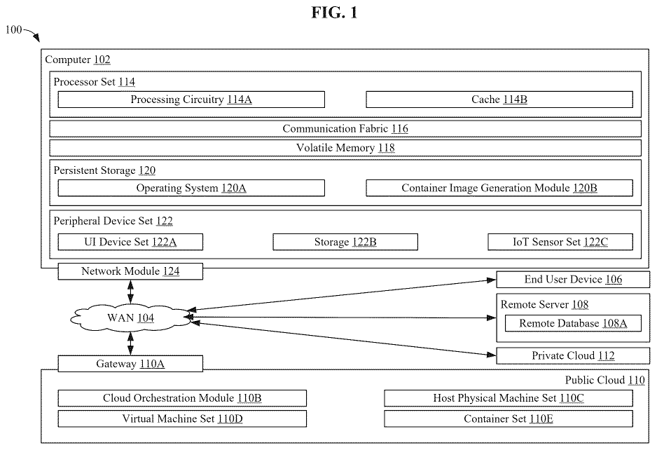

FIG. 1 is a diagram that illustrates a computing environment for generation of a multi-stage container image using Artificial Intelligence (AI), in accordance with an embodiment of the disclosure. With reference to FIG. 1, there is shown a computing environment 100 that contains an example of an environment for the execution of at least some of the computer code involved in performing the disclosed methods, such as a container image generation module 120B. In addition to the container image generation module 120B, computing environment 100 includes, for example, a computer 102, a wide area network (WAN) 104, an end user device (EUD) 106, a remote server 108, a public cloud 110, and a private cloud 112. In an embodiment of the disclosure, the computer 102 includes a processor set 114 (including a processing circuitry 114A and a cache 114B), a communication fabric 116, a volatile memory 118, a persistent storage 120 (including an operating system 120A and the container image generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as a remote database 108A. As is well understood in the art of computer technology, and depending upon the technology, the performance of a computer-implemented method may be distributed among multiple computers and/or between multiple locations. In the presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the container image generation module 120B in persistent storage 120.

The communication fabric 116 is the signal conduction path that allows the various components of computer 102 to communicate with each other. Typically, the communication fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the container image generation module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running. A computer program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

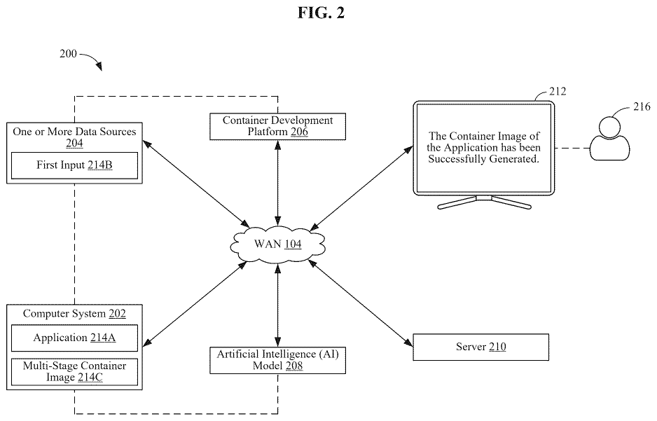

FIG. 2 is a diagram that illustrates an environment for generation of a multi-stage container image using artificial intelligence (AI), in accordance with an embodiment of the disclosure. FIG. 2 is explained in conjunction with elements from FIG. 1. With reference to FIG. 2, there is shown a diagram of a network environment 200. The network environment 200 includes a computer system 202, one or more data sources 204, a container development platform 206, an artificial intelligence (AI) model 208, a server 210, and a user device 212. The computer system 202 generates a multi-stage container image 214C (may also be referred to as container image 214C, hereinafter) of an application 214A. The one or more data sources 204 includes a first input 214B. The user device 212 is further associated with a user 216. The network environment 200 further includes the WAN 104 of FIG. 1. In an embodiment of the disclosure, the user device 212 is an exemplary embodiment of the EUD 106. Similarly, the computer system 202 is an exemplary embodiment of the computer 102 in FIG. 1.

The computer system 202 includes suitable logic, circuitry, code, and/or interfaces that are configured to generate the multi-stage container image 214C of the application 214A by independent stage splitting of the application 214A and further debugging a set of instructions associated with the application 214A based on the independent stage splitting. Specifically, the computer system 202 retrieves the first input 214B which includes a set of instructions associated with the application 214A. The computer system 202 further generates a set of build stages based on the first input 214B. Each build stage of the set of build stage includes a corresponding subset of instructions of the set of instructions. The computer system 202 further identifies a first set of errors associated with a first subset of instructions of the set of instructions. The first subset of instructions is associated with a first build stage of the set of build stages. The computer system 202 further applies the AI model 208 to the first set of errors. The computer system 202 further resolves the first set of errors based on the application of the AI model 208 to the first set of errors. The computer system 202 further generates a first portion of the multi-stage container image 214C based on the resolution of the first set of errors. The computer system 202 further outputs the first portion of the multi-stage container image 214C of the application 214A.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from a computer system (such as the computer system 202). Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment of the disclosure, the one or more data sources 204 are connected to the application programming interfaces (APIs) of the container development platform 206. In an embodiment of the disclosure, each data source of the one or more data sources 204 stores the first input 214B. The first input 214B includes a set of instructions associated with the application 214A. In an embodiment of the disclosure, the computer system 202 utilizes each instruction of the set of instructions to generate the multi-stage container image 214C of the application 214A.

Examples of each instruction of the set of instructions include at least one of but are not limited to, a “RUN” instruction, an “ADD” instruction, a “FROM” instruction, a “COPY” instruction, a “CMD” instruction, an “ENTRYPOINT” instruction, or the like. Examples of each data source of one or more data sources 204 may include but are not limited to, a relational database, a Non-Structured Query Language (SQL) database, a hierarchical database, a network database, a transactional database, a data warehouse, and a distributed database.

The container development platform 206 includes suitable logic, code, and circuitry that is configured to create, deploy, and manage container images of applications within lightweight, portable containers. The container development platform 206 ensures that applications, along with the dependencies, are encapsulated in a manner that guarantees consistent performance across various computing environments, thereby addressing compatibility issues that may arise during the software development lifecycle. The architecture of the container development platform 206 allows for efficient resource utilization, rapid deployment, and seamless scalability, enabling organizations to optimize the operational workflows and enhance productivity.

In an embodiment of the disclosure, the container development platform 206 is implemented as a plurality of distributed cloud-based resources by use of several technologies that are well known to those ordinarily skilled in the art. A person with ordinary skill in the art will understand that the scope of the disclosure may not be limited to the implementation of the container development platform 206 and the computer system 202 as two separate entities. In certain embodiments, the functionalities of the container development platform 206 can be incorporated in its entirety or at least partially in the computer system 202, without a departure from the scope of the disclosure.

The AI model 208 corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of the nodes in the input layer may be coupled to at least one node of the hidden layer(s). Similarly, the inputs of each hidden layer are coupled to outputs of at least one node in various layers of the neural network. Outputs of each hidden layer may be coupled to inputs of at least one node in the various layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on the training dataset 214. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in various layer(s) (e.g., previous layer(s)) of the neural network. The nodes of the neural network correspond to the same or a different mathematical function.

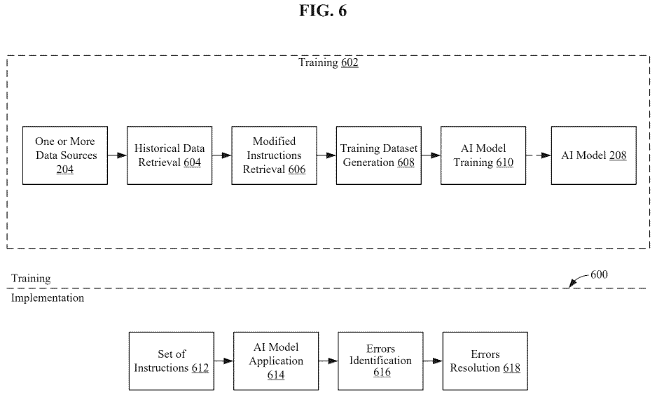

In the training of the AI model 208, one or more parameters of each node of the AI model 208 may be updated based on whether an output of the final layer for a given input (from the training dataset) matches a correct result based on a loss function for the AI model 208. The above process may be repeated for the same or a different input until a minima of loss function may be achieved, and a training error may be minimized. Details about the training of the AI model 208 are provided, for example, in FIG. 6.

The neural network includes electronic data, such as, for example, a software program, code of the software program, libraries, applications, scripts, or various logics or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software.

Accordingly, in some embodiments, the AI model 208 is a separate entity in the computer system 202, without deviation from the scope of the disclosure.

In an embodiment of the disclosure, the AI model 208 is configured to identify the first set of errors associated with the first subset of instructions. The computer system 202 trains the AI model 208 to identify the first set of errors based on the first subset of instructions. The AI model 208 identifies patterns and relationships between the first subset of instructions and its training data to identify the first set of errors. The AI model 208 is further configured to resolve the first set of errors. The computer system 202 similarly trains the AI model 208 to resolve the first set of errors. The AI model 208 identifies the patterns and relationships between the first set of errors and its training data to resolve the first set of errors. Details about the training of the AI model 208 are provided, for example, in FIG. 6.

In an embodiment of the disclosure, the computer system 202 stores the AI model 208. In an alternate embodiment of the disclosure, the AI model 208 is embodied as a separate entity that is implemented as a set of distributed cloud-based resources by use of several technologies that are well known to those ordinarily skilled in the art. Examples of the AI model 208 include one of but are not limited to, an artificial neural network (ANN), a deep neural network (DNN), a convolutional neural network (CNN), a fully connected neural network, and/or a combination of such networks.

The server 210 includes suitable logic, circuitry, interfaces, and/or code that stores the set of instructions. The server 210 can be implemented as a cloud server and may execute operations through web applications, cloud applications, HTTP requests, repository operations, file transfer, and the like. Various example implementations of the server 210 include but are not limited to, a database server, a file server, a web server, a media server, an application server, a mainframe server, or a cloud computing server.

In an embodiment of the disclosure, the server 210 is implemented as a plurality of distributed cloud-based resources by use of several technologies that are well known to those ordinarily skilled in the art. A person with ordinary skill in the art will understand that the scope of the disclosure may not be limited to the implementation of the server 210 and the computer system 202 as two separate entities. In certain embodiments, the functionalities of the server 210 can be incorporated in its entirety or at least partially in the computer system 202, without a departure from the scope of the disclosure.

The user device 212 includes suitable logic, circuitry, and/or interfaces that are configured to execute one or more tasks within the network environment 200. The user device 212 performs the one or more tasks such as receiving data, processing the data, and transmitting the data. In an embodiment of the disclosure, the computer system 202 receives the first input 214B from the user device 212. The computer system 202 receives the set of instructions from the user device 212.

In an alternate embodiment of the disclosure, the computer system 202 renders a message on the user device 212. The message is associated with the generation of the multi-stage container image 214C of the application 214A. By way of example, and not by limitation, the message may be “The container image of the application has been successfully generated”. Examples of the user device 212 include one but are not limited to, a smartphone, a cellular phone, a mobile phone, a consumer electronic (CE) device, an Internet of Things (IOT) device, a computing device, a mainframe machine, a server, a computer workstation, or the like.

The application 214A includes suitable logic and/or code that is designed to perform specific tasks or functions, which can range from web services to data processing tools. Specifically, the application 214A is built using various programming languages and frameworks, and the application 214A relies on specific dependencies and configurations to operate effectively. By way of example, and not by limitation, the application 214A could be a website that serves dynamic content, a database management system, a microservice that handles user authentication, and the like. The first input 214B includes the set of instructions associated with the application 204A. In an embodiment, the computer system 202 utilizes each instruction of the set of instructions to generate the multi-stage container image 214C.

The multi-stage container image 214C of the application 214A is a lightweight, standalone, and executable package that includes suitable logic and/or code that is needed to run the application on various container orchestration platforms. The multi-stage container image 214C includes application code, runtime environment, libraries, and system tools associated with the application 214A that are needed to run the application 214A on the various container orchestration platforms. The computer system 202 generates the multi-stage container image 214C in multiple portions (or multiple stages).

In an embodiment of the disclosure, each portion of the multi-stage container image 214C includes a base layer and subsequent layers. Each portion of the multi-stage container image 214C is associated with a respective build stage of the set of build stages of the multi-stage container image 214C. The base layer includes the operating system and the critical tools for building the application 214A. The subsequent layers include various dependencies that are critical for the multi-stage container image 214C to run effectively.

In operation, the computer system 202 retrieves the first input 214B which includes the set of instructions associated with the application 214A. In an embodiment of the disclosure, the computer system 202 retrieves the set of instructions from the one or more data sources 204. As discussed above, the one or more data sources 204 are connected with the APIs of the container development platform 206. In an embodiment of the disclosure, the computer system 202 obtains the multi-stage container image 214C via API calls. In an embodiment of the disclosure, the computer system 202 utilizes each instruction of the set of instructions to generate the multi-stage container image 214C of the application 214A.

Examples of each instruction of the set of instructions include at least one of but are not limited to, a “RUN” instruction, an “ADD” instruction, a “FROM” instruction, a “COPY” instruction, a “CMD” instruction, an “ENTRYPOINT” instruction, or the like. By way of example, and not by limitation, the computer system 202 retrieves the set of instructions given below:
FROM ubuntu as builder
RUN make build
RUN <pip install python>
FROM python: 3.10
RUN python a.py

Thereafter, the computer system 202 generates the set of build stages based on the first input 214B. Each build stage of the set of build stages includes the corresponding subset of instructions of the set of instructions. Specifically, the computer system 202 applies one or more rules to the first input 214B and then generates the set of build stages based on the application of the one or more rules. The computer system 202 parses the set of instructions and then generates the set of build stages based on the parsed set of instructions. In an embodiment of the disclosure, the computer system 202 utilizes each build stage of the set of build stages to generate a respective portion of the multi-stage container image 214C.

In an embodiment of the disclosure, the computer system 202 parses the set of instructions to identify a starting point of a “FROM” instruction and then generates the set of build stages based on the identification of the starting point of “FROM instruction”. By way of example, and not by limitation, the set of build stages is provided in Table 1 below:

TABLE 1
Set of Build Stages

| Build Stage | Instructions |
|---|---|
| 1 | FROM ubuntu as builder |
| | RUN make build |
| | RUN <pip install python> |
| 2 | FROM python: 3.10 |
| | RUN python a.py |

Further, the computer system 202 identifies the first set of errors associated with the first subset of instructions of the set of instructions. The first subset of instructions is associated with the first build stage of the set of build stages. Each error of the first set of errors refers to any issues within the set of instructions that reduce the functionality or performance of the application 214A. The first set of errors includes actual runtime errors and compile time errors (that include syntax errors and semantic errors) that prevent the application 214A from executing correctly. The first set of errors is further associated with inefficiencies or complexities that are associated with excessive resource usage, redundant complexities, redundant dependencies, and memory leaks.

Specifically, the computer system 202 applies the AI model 208 to the first subset of instructions associated with the first build stage and then identifies the first set of errors based on the application of the AI model 208 to the first subset of instructions associated with the first build stage. By way of example, and not by limitation, the computer system 202 identifies a syntax error in a specific instruction of the first subset of instructions as “RUN <pip install python>”. The error encountered with the instruction “RUN <pip install python>” is that the error indicates that the GNU Compiler Collection (GCC), which includes the C compiler, is missing from the environment.

Further, the computer system 202 applies the AI model 208 to the first set of errors associated with the first build stage. The AI model 208 is trained to resolve the first set of errors. The AI model 208 identifies the patterns and the relationships in the first set of errors based on its training data and then resolves the first set of errors. By way of example, and not by limitation, the AI model 208 resolves the first set of errors by providing a modified instruction “RUN<pip install gcc python>”. Since the term “gcc” was missing in the instruction, the AI model 208 modified the instruction to add the term “gcc”. Details about the training of the AI model 208 are provided, for example, in FIG. 6.

Thereafter, the computer system 202 resolves the first set of errors based on the application of the AI model 208 to the first set of errors. Specifically, the computer system 202 modifies the first subset of instructions associated with the first build stage based on the resolution of the first set of errors. The computer system 202 generates the modified first subset of instructions to resolve the first set of errors. Each instruction of the modified first subset of instruction is a resolution of a respective error of the first set of errors. By way of example, and not by limitation, the computer system 202 modifies the specific instruction “RUN <pip install python>” as “RUN<pip install gcc python>”. The error encountered with the instruction “RUN <pip install python>” was that the error indicated that the GNU Compiler Collection (GCC), which includes the C compiler, is missing from the environment. The absence of GCC prevented the successful installation of the g++ package, as g++ relies on GCC to function properly. By generating the modified instruction “RUN<pip install gcc python>”, the computer system 202 resolves the error by explicitly including the installation of GCC alongside g++. In this manner, the computer system 202 ensures that both compilers are available in the environment, allowing g++ to operate correctly and enabling the application to compile C++ code without issues. The modified instruction not only addresses the error but also enhances the overall development environment by providing the critical tools for compiling both C and C++ programs.

Further, the computer system 202 generates the first portion of the multi-stage container image 214C based on the resolution of the first set of errors. Specifically, the computer system 202 modifies the first subset of instructions based on the resolution of the first set of errors and executes the modified first subset of instructions. In an embodiment of the disclosure, the computer system 202 generates the first portion of the multi-stage container image 214C based on the execution of the modified first subset of instructions. By way of example, and not by limitation, the computer system 202 generates the first portion of the multi-stage container image 214C based on the execution of the modified first subset of instructions given below:
FROM ubuntu as builder
RUN make build
RUN <pip install gcc python>

To this end, the computer system 202 outputs the first portion of the multi-stage container image 214C. In an embodiment of the disclosure, the computer system 202 stores the first portion of the multi-stage container image 214C into the one or more data sources 204. In an alternate embodiment of the disclosure, the computer system 202 transmits the first portion of the multi-stage container image 214C to the container development platform 206. The computer system 202 further generates a second portion of the multi-stage container image 214C based on the stored first portion.

Since the computer system 202 utilizes the stored first portion (debugged first subset of instructions) to generate the second portion of the multi-stage container image 214C, therefore, in case a second set of errors is identified in a second build stage of the set of build stages, then the computer system 202 need not to regenerate the first portion of the container image 214C. In that scenario, the computer system 202 regenerates only the second portion of the container image 214C and utilizes the stored first portion (the debugged first subset of instructions) to generate the multi-stage container image 214C. Hence, the computer system 202 reduces the processing time of the process of debugging multi-stage container images by independent stage splitting and automating the debugging process, thereby solving the problems of the traditional methods.

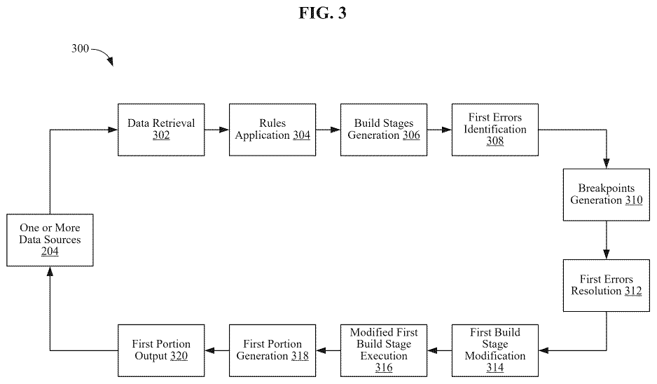

FIG. 3 is a diagram that illustrates first exemplary operations for generation of a multi-stage container image using artificial intelligence (AI), in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 320, as described herein. The exemplary operations illustrated in the block diagram 300 start at 302 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

At 302, a data retrieval operation is performed. In the data retrieval operation, the computer system 202 retrieves the first input 214B which includes the set of instructions associated with the application 214A. In an embodiment of the disclosure, the computer system 202 retrieves the set of instructions from the one or more data sources 204. As discussed above, the one or more data sources 204 are connected with the APIs of the container development platform 206. In an embodiment of the disclosure, the computer system 202 obtains the multi-stage container image 214C via the API calls. In an embodiment of the disclosure, the computer system 202 utilizes each instruction of the set of instructions to generate the multi-stage container image 214C of the application 214A.

Examples of each instruction of the set of instructions include at least one of but are not limited to, a “RUN” instruction, an “ADD” instruction, a “FROM” instruction, a “COPY” instruction, a “CMD” instruction, an “ENTRYPOINT” instruction, or the like. By way of example, and not by limitation, the computer system 202 retrieves the set of instructions given below:
FROM alpine: latest as builder
RUN apk add --no-cache g++
RUN make build
FROM ubuntu:20.04
RUN make install

At 304, a rules application operation is performed. In the rules application operation, the computer system 202 applies the one or more rules to the first input 214B. In an embodiment of the disclosure, the computer system 202 parses the set of instructions included the first input 214B and then applies the one or more rules. The one or more rules include identifying a starting point of “FROM instruction” in the set of instructions. In an embodiment, the computer system 202 parses the set of instructions and then identifies the starting point of the “FROM” instruction in the set of instructions.

At 306, a build stages generation operation is performed. In the build stages generation operation, the computer system 202 generates the set of build stages based on the application of the one or more rules to the first input 214B. Each build stage of the set of build stages includes the corresponding subset of instructions of the set of instructions. The computer system 202 utilizes each build stage of the set of build stages to generate a respective portion of the container image. For example, the first build stage includes the first subset of instructions, a second build stage includes a second subset of instructions of the set of instructions, and the like.

In an embodiment of the disclosure, the computer system 202 parses the set of instructions to identify a starting point of a “FROM” instruction and then generates the set of build stages based on the identification of the starting point of “FROM instruction”. By way of example, and not by limitation, the set of build stages is provided in Table 2 below:

TABLE 2
Set of Build Stages

| Build Stage | Instructions |
|---|---|
| 1 | FROM alpine: latest as builder |
| | RUN apk add --no-cache g++ |
| | RUN make build |
| 2 | FROM ubuntu: 20.04 |
| | RUN make install |

At 308, a first errors identification operation is performed. In the first errors identification operation, the computer system 202 identifies the first set of errors in the first subset of instructions associated with the first build stage. Each error of the first set of errors refers to any issues within the set of instructions that reduce the functionality or performance of the application 214A. The first set of errors includes actual runtime errors and compile time errors (that include syntax errors and semantic errors) that prevent the application 214A from executing correctly. The first set of errors is further associated with inefficiencies or complexities that are associated with excessive resource usage, redundant complexities, redundant dependencies, and memory leaks. In this context, “executing correctly” refers to the application 214A performing its intended functions without producing incorrect results. The “executing correctly” indicates that the application 214A can complete the tasks of the application 214A, accurately perform data processing, and engage with proper user interactions. When the application 214A fails to execute correctly, the application 214A may even lead to data loss, or even security vulnerabilities.

For example, the first set of errors may further include logical errors, which occur when the code runs without any problems but produces incorrect results. Additionally, the first set of errors may further include performance errors, such as memory leaks or inefficient algorithms, which can degrade the application's responsiveness and resource usage over time. Addressing these first set of errors is critical for ensuring that an application not only runs but also performs its functionality properly without malfunctions such as data loss.

Specifically, the computer system 202 applies the AI model 208 to the first subset of instructions associated with the first build stage and then identifies the first set of errors based on the application of the AI model 208 to the first subset of instructions associated with the first build stage based on the application of the AI model 208 to the first subset of instructions. As discussed above, the AI model 208 is trained to identify the errors based on the set of instructions. Further, the AI model 208 analyzes the first subset of instructions based on its training data and identifies the errors. By way of example, and not by limitation, the computer system 202 identifies a syntax error in a specific instruction of the first subset of instructions as “RUN apk add --no-cache g++”. The error encountered with the instruction “RUN apk add --no-cache g++” indicates that the GNU Compiler Collection (GCC), which includes the C compiler, is missing from the environment. The absence of the GCC prevents the successful installation of the g++ package, as g++ relies on GCC to function properly. Details about the training of the AI model 208 are provided, for example, in FIG. 6.

At 310, a breakpoints generation operation is performed. In the breakpoints generation operation, the computer system 202 generates one or more breakpoints in the first subset of instructions based on the identified first set of errors. Each breakpoint of the set of breakpoints is a specific point in the set of instructions where the computer system 202 pauses the execution of the set of instructions for determining the current state of the application 214A, including variable values, memory usage, and control flow.

The computer system 202 generates the one or more breakpoints to isolate and examine critical sections of the build process. By pausing execution at these points, the computer system 202 determines that critical portions of the set of instructions are functioning correctly before proceeding further for the resolution of the errors. Therefore, the computer system 202 reduces the overall processing time in debugging the multi-stage container image 214C by enabling targeted inspection and troubleshooting rather than sifting through the entire build process of the multi-stage container image 214C. By way of example, and not by limitation, the computer system 202 generates a breakpoint just after the specific instruction “RUN apk add --no-cache g++” in the first subset of instructions.

At 312, a first errors resolution operation is performed. In the first errors resolution operation, the computer system 202 resolves the first set of errors based on the generated one or more breakpoints. The computer system 202 parses the first subset of instructions until a first breakpoint of the one or more breakpoints, resolves the specific error, and then continues debugging the rest of the first subset of instructions similarly.

Specifically, the computer system 202 applies the AI model 208 to the first set of errors and then resolves the first set of errors based on the application of the AI model to the first set of errors. The AI model 208 is trained to resolve the first set of errors. The AI model 208 identifies the patterns and the relationships in the first set of errors based on its training data and then resolves the first set of errors. By way of example, and not by limitation, the AI model 208 resolves the first set of errors by generating a modified instruction “RUN apk add --no-cache gcc g++”. Details about the training of the AI model 208 are provided, for example, in FIG. 6.

At 314, a first build stage modification operation is performed. In the first build stage modification operation, the computer system 202 modifies the first subset of instructions associated with the first build stage based on the resolution of the first set of errors. In an embodiment, the computer system 202 generates the modified first subset of instructions to resolve the first set of errors that were associated with the first subset of instructions. Each instruction of the modified first subset of instruction is a resolution of the respective error of the first set of errors. Specifically, the computer system 202 modifies the first subset of instructions to correct the identified runtime errors and the compile time errors (that include syntax errors and semantic errors) that prevent the application 214A from executing correctly. In an embodiment of the disclosure, the computer system 202 further modifies the first subset of instructions to remove the inefficiencies or the complexities that are associated with excessive resource usage, redundant complexities, redundant dependencies, and memory leaks.

By way of example, and not by limitation, the computer system 202 modifies the specific instruction “RUN apk add --no-cache g++” as “RUN apk add --no-cache gcc g++”. The computer system 202 generates the modified specific instruction “RUN apk add --no-cache gcc g++”. The error encountered with the instruction “RUN apk add --no-cache g++” was that the error indicated that the GNU Compiler Collection (GCC), which includes the C compiler, is missing from the environment. The absence of GCC prevented the successful installation of the g++ package, as g++ relies on GCC to function properly. By generating the modified instruction “RUN apk add --no-cache gcc g++”, the computer system 202 resolves the error by explicitly including the installation of GCC alongside g++. In this manner, the computer system 202 ensures that both compilers are available in the environment, allowing g++ to operate correctly and enabling the application to compile C++ code without issues. The modification of the instruction not only addresses the error but also enhances the overall development environment by providing the critical tools for compiling both C and C++ programs.

At 316, a modified first build stage execution operation is performed. In the modified first build stage execution operation, the computer system 202 executes the modified first subset of instructions associated with the first build stage. The computer system 202 executes the modified first subset of instructions to generate the first portion of the container) image 214C. By way of example, and not by limitation, the computer system 202 executes the modified first subset of instructions given below:
FROM alpine: latest as builder
RUN apk add --no-cache gcc g++
RUN make build

At 318, a first portion generation operation is performed. In the first portion generation operation, the computer system 202 generates the first portion of the multi-stage container image 214C based on the execution of the modified first subset of instructions. Each portion of the multi-stage container image includes a base layer and subsequent layers. Each portion of the multi-stage container image 214C is associated with a respective build stage of the set of build stages of the multi-stage container image 214C. The base layer includes the operating system and the critical tools for building the application 214A. The subsequent layers include various dependencies that are critical for the multi-stage container image 214C to run effectively.

At 320, a first portion output operation is performed. In the first portion output operation, the computer system 202 outputs the first portion of the multi-stage container image 214C. In an embodiment of the disclosure, the computer system 202 stores the first portion of the multi-stage container image 214C into the one or more data sources 204. In an alternate embodiment of the disclosure, the computer system 202 transmits the first portion of the multi-stage container image 214C to the container development platform 206. The computer system 202 further generates a second portion of the multi-stage container image 214C based on the stored first portion.

Since the computer system 202 utilizes the stored first portion (debugged first subset of instructions) to generate the second portion of the multi-stage container image 214C, therefore, in case the second set of errors is identified in a second build stage of the set of build stages, then the computer system 202 does not regenerate the first portion of the container image 214C. In that scenario, the computer system 202 regenerates only the second portion of the container image 214C and utilizes the stored first portion (the debugged first subset of instructions) to generate the multi-stage container image 214C. Hence, the computer system 202 reduces the processing time of the process of debugging multi-stage container images by independent stage splitting and automating the debugging process, thereby solving the problems of the traditional methods.

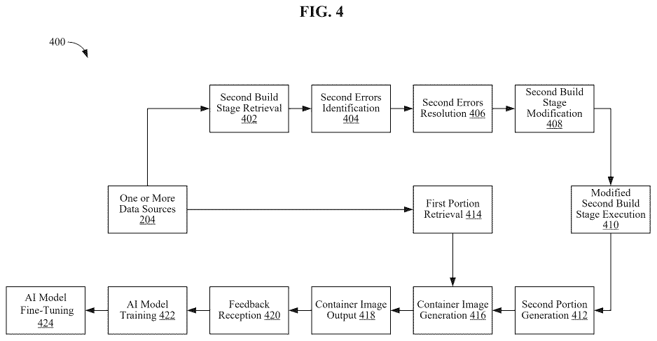

FIG. 4 is a diagram that illustrates second exemplary operations for generation of a multi-stage container image using artificial intelligence (AI), in accordance with an embodiment of the disclosure. FIG. 4 is explained in conjunction with elements from FIG. 1, FIG. 2, and FIG. 3. With reference to FIG. 4, there is shown the block diagram 400 that illustrates exemplary operations from 402 to 424, as described herein. The exemplary operations illustrated in the block diagram 400 start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400 can be divided into additional blocks, combined into fewer blocks, or eliminated, depending on the implementation.

At 402, a second build stage retrieval operation is performed. In the second build stage retrieval operation, the computer system 202 retrieves the second subset of instructions associated with the second build stage. The computer system 202 retrieves the second subset of instructions to generate the second portion of the multi-stage container image 214C. By way of example, and not by limitation, the computer system 202 retrieves the second subset of instructions from Table 2 provided above in the description of FIG. 3. The second subset of instructions is given below:
FROM ubuntu:20.04
RUN make install

At 404, a second errors identification operation is performed. In the second errors identification operation, the computer system 202 identifies a second set of errors in the second subset of instructions associated with the second build stage. The second set of errors refers to any issues within the set of instructions that reduce the functionality or performance of the application 214A. The second set of errors includes actual runtime errors and compile time errors (that include syntax errors and semantic errors) that prevent the application 214A from executing correctly. The second set of errors is further associated with inefficiencies or complexities that are associated with excessive resource usage, redundant complexities, redundant dependencies, and memory leaks.

Specifically, the computer system 202 applies the AI model 208 to the second subset of instructions associated with the second build stage. Then, the computer system 202 identifies the second set of errors based on the application of the AI model 208 to the second subset of instructions associated with the second build stage. The AI model 208 is trained to identify the errors based on the set of instructions. The AI model 208 analyzes the second subset of instructions based on its training data and identifies the errors. Details about the training of the AI model 208 are provided, for example, in FIG. 6.

By way of example, and not by limitation, the computer system 202 identifies a specific error that to execute the “RUN make install” instruction, the relevant files need to be copied from the builder stage. The second subset of instructions “FROM ubuntu: 20.04” followed by “RUN make install” suggest that the installation process is attempting to execute a build or installation command directly within the base Ubuntu image. The second subset of instructions may lead to incorrect results if the critical build artifacts or dependencies are not present in the environment. Therefore, the computer system 202 identifies that a “COPY” instruction is missing in the second subset of instructions for the generation of the second portion of the multi-stage container image 214C.

At 406, a second errors resolution operation is performed. In the second errors resolution operation, the computer system 202 resolves the second set of errors. In an embodiment of the disclosure, the computer system 202 applies the AI model 208 to resolve the second set of errors associated with the second build stage. The AI model 208 is trained to resolve the second set of errors. The AI model 208 identifies the patterns and the relationships in the second set of errors based on its training data and then resolves the second set of errors. Details about the training of the AI model 208 are provided, for example, in FIG. 6.

By way of example, and not by limitation, the AI model 208 resolves the second set of errors by adding a “COPY” instruction “COPY --from=builder/path/to/built/files/desired/path” in the second subset of instructions associated with the second build stage. Therefore, the computer system 202 copies the relevant files from the builder stage that were missing for the generation of the second portion of the container image 214C.

At 408, a second build stage modification operation is performed. In the second build stage modification operation, the computer system 202 modifies the second set of instructions associated with the second build stage based on the resolution of the second set of errors. Each instruction of the modified second subset of instruction is a resolution of the respective error of the second set of errors. Specifically, the computer system 202 modifies the second subset of instructions to correct the identified runtime errors and the compile time errors (that include syntax errors and semantic errors) that prevent the application 214A from executing correctly. In an embodiment of the disclosure, the computer system 202 further modifies the second set of instructions to remove the inefficiencies or the complexities that are associated with excessive resource usage, redundant complexities, redundant dependencies, and memory leaks.

By way of example, and not by limitation, the computer system 202 adds the specific instruction “COPY--from=builder/path/to/built/files/desired/path” in the second subset of instructions just before the “RUN make install” instruction. The second subset of instructions “FROM ubuntu:20.04” followed by “RUN make install” suggest that the installation process is attempting to execute a build or installation command directly within the base Ubuntu image. The second subset of instructions may lead to incorrect results if the critical build artifacts or dependencies are not present in the environment. By generating a modified second subset of instructions, and more specifically by adding the instruction “COPY--from-builder/path/to/built/files/desired/path” before the “RUN make install” command, the computer system 202 resolves the issue by first copying the pre-built files from a designated builder stage into the desired location within the Ubuntu image. In this manner, the computer system 202 ensures that the critical files are available for the installation process, allowing “make install” to execute successfully without encountering missing dependencies or files, thereby streamlining the build process and enhancing the reliability of the final image.

At 410, a modified second build stage execution operation is performed. In the modified second build stage execution operation, the computer system 202 executes the modified second subset of instructions associated with the second build stage. In an embodiment of the disclosure, the computer system 202 executes the second subset of instructions based on the generated first portion. Since the computer system 202 ensures that the first set of errors are already resolved in the generated first portion, therefore, the computer system 202 further ensures that there are no additional errors in the execution of the second set of instructions due to the first build stage.

The computer system 202 executes the modified second subset of instructions to generate the second portion of the container image 214C. By way of example, and not by limitation, the computer system 202 executes the modified second subset of instructions given below:
FROM ubuntu:20.04
COPY--from=builder/path/to/built/files/desired/path
RUN make install

At 412, a second portion generation operation is performed. In the second portion generation operation, the computer system 202 generates the second portion of the multi-stage container image 214C based on the execution of the modified second subset of instructions. In an embodiment of the disclosure, the computer system 202 generates the second portion of the container image 214C based on the resolution of the second set of errors and the generated first portion (the debugged first subset of instructions). The second portion similarly includes the base layer, and the subsequent layers as discussed above.

In an embodiment of the disclosure, the computer system 202 further outputs the generated second portion of the container image 214C. Specifically, the computer system 202 similarly stores the generated second portion. In an alternate embodiment of the disclosure, the computer system 202 transmits the first portion of the multi-stage container image 214C to the container development platform 206. The computer system 202 stores the generated first portion and the generated second portion to generate the next portions (next stages) of the multi-stage container image 214C.

At 414, a first portion retrieval operation is performed. In the first portion retrieval operation, the computer system 202 retrieves the stored first portion of the multi-stage container image 214C from the one or more data sources 204. Details about the generation and the storage of the first portion of the multi-stage container image 214C are provided, for example, at operation 318 and operation 320 in FIG. 3.

At 416, a container image generation operation is performed. In the container image generation operation, the computer system 202 generates the multi-stage container image 214C of the application 214A based on the first portion and the second portion. Specifically, the computer system 202 combines the stored first portion and the stored second portion of the multi-stage container image 214C to generate the multi-stage container image 214C.

Since the computer system 202 utilizes the stored first portion and the stored second portion (debugged subset of instructions) to generate the next portions of the multi-stage container image 214C, therefore, in case a next set of errors is identified in a next build stage of the set of build stages, then the computer system 202 does not regenerate the first portion and the second portion of the container image 214C. In that scenario, the computer system 202 regenerates only the next portions of the container image 214C and utilizes the stored first portion and the second portion to generate the multi-stage container image 214C. Hence, the computer system 202 reduces the processing time of the process of debugging multi-stage container images by independent stage splitting and automating the debugging process, thereby solving the problems of the traditional methods.

At 418, a container image output operation is performed. In the container image output operation, the computer system 202 outputs the multi-stage container image 214C. In an embodiment of the disclosure, the computer system 202 stores the multi-stage container image 214C. In an alternate embodiment of the disclosure, the computer system 202 transmits the generated multi-stage container image 214C to the container development platform 206.

At 420, a feedback reception operation is performed. In the feedback reception operation, the computer system 202 receives feedback associated with the generated multi-stage container image 214C from the user device 212. The feedback refers to a response of the user 216 for the generated multi-stage container image 214C. The feedback can be one of positive feedback or negative feedback. The positive feedback indicates that the generated multi-stage container image 214C is accurate. The accurate feedback indicates that the generated container image is correct (and as per the needs of the user). The negative feedback indicates that the generated multi-stage container image 214C is inaccurate and the AI model 208 needs to be fine-tuned for the resolution of the errors. The inaccurate feedback indicates that the generated container image 214C is inaccurate (not as per the needs of the user) and the container image 214C needs to be modified.

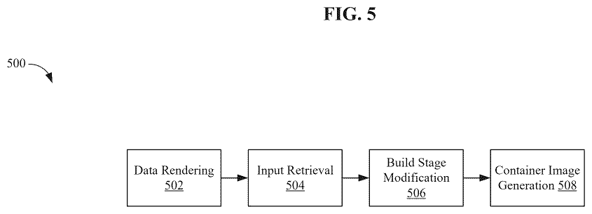

In case the user finds an automated correction to be incorrect or if the user wants to proceed with a manual correction, then the computer system 202 receives a specific modified instruction. In that case, the specific modified instruction indicates the negative feedback. The computer system 202 obtains the specific modified instruction and further performs the fine-tuning of the AI model based on the specific modified instruction. Details about the retrieval of the specific modified instruction are further provided, for example, in FIG. 5.

At 422, an AI model training operation is performed. In the AI model training operation, the computer system 202 trains the AI model 208 based on the feedback. In case of the positive feedback, the computer system 202 reinforces the estimated weights and the hyperparameters of the AI model 208 to ensure that the generation of the next multi-stage container images is also correct.

In case of the negative feedback, the computer system 202 adjusts the estimated weights and the hyperparameters of the AI model 208 until the predicted output (e.g. a predicted modified instruction) is equal to the received specific modified instruction or until the minima of the loss function is achieved or the training error is minimized. Details about the training of the AI model 208 are further provided, for example, in FIG. 6.

At 424, an AI model fine-tuning operation is performed. In the AI model fine-tuning operation, the computer system 202 fine-tunes the AI model 208 after the training of the AI model 208. In an embodiment, the computer system 202 fine-tunes (or adjusts) the weights and the hyperparameters of the neural network corresponding to the AI model 208 until an accuracy score of the predictions of the AI model is greater than a threshold accuracy score. The accuracy score is a performance metric of the AI model 208 that is used to measure the performance of the AI model 208 in terms of the number of correct predictions relative to the number of incorrect predictions. The computer system 202 fine-tunes the AI model to ensure that the performance of the AI model 208 in terms of the accuracy score in resolving the first set of errors is greater than the threshold accuracy score. The computer system 202 further fine-tunes the AI model 208 to ensure that future (or next) generation of the multi-stage container images are precise, accurate, and correct. In this manner, the computer system 202 ensures that the multi-stage container images generated in the future are according to the needs of the user.

FIG. 5 is a diagram that illustrates third exemplary operations for generation of a multi-stage container image using artificial intelligence (AI), in accordance with an embodiment of the disclosure. FIG. 5 is explained in conjunction with elements from FIG. 1, FIG. 2, FIG. 3, and FIG. 4. With reference to FIG. 5, there is shown the block diagram 500 that illustrates exemplary operations from 502 to 508, as described herein. The exemplary operations illustrated in the block diagram 500 start at 502 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 500 can be divided into additional blocks, combined into fewer blocks, or eliminated, depending on the implementation.

At 502, a data rendering operation is performed. In the data rendering operation, the computer system 202 renders the first set of errors and the modified first subset of instructions on the user device 212. The computer system 202 renders the first set of errors and the modified first subset of instructions to ensure that the resolution of the first set of errors by the AI model 208 is correct.

In an embodiment of the disclosure, the computer system 202 similarly renders the next set of errors and the next set of instructions for verification. By way of example, and not by limitation, the computer system 202 renders the first set of errors “RUN <pip install python>” and the modified first subset of instructions “RUN <pip install gcc python>” on the user device 212 for verification.

Hence, the computer system 202 provides an interactive user interface (UI) for the resolution of the errors and the debugging process during the generation of the multi-stage container image 214C. Therefore, the computer system 202 solves the problems associated with the traditional methods that were majorly dependent on command-line interfaces for the resolution of the errors.

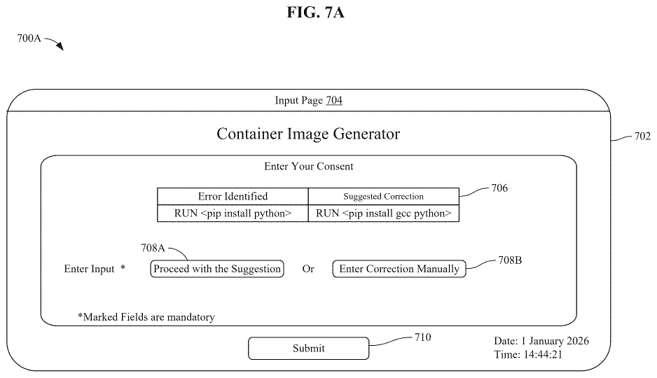

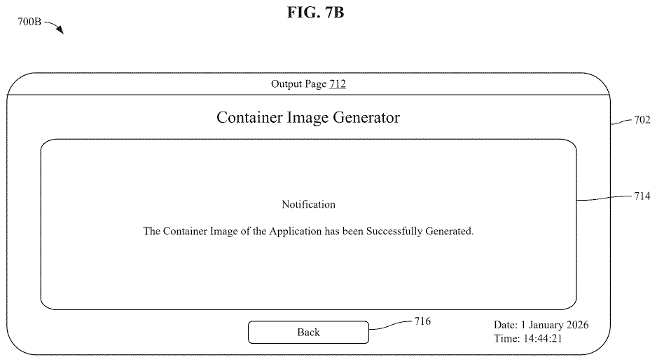

At 504, an input retrieval operation is performed. In the input retrieval operation, the computer system 202 retrieves a second input associated with the first set of errors from the user device 212. In case the modified first subset of instructions (modified by the computer system 202) is correct, then the computer system 202 receives a message in the second input that indicates that the resolution of the first set of errors is correct. In case the modified first subset of instructions (modified by the computer system 202) is incorrect, then the computer system 202 receives specific modified instructions in the second input for correcting the first set of errors. Details about the input retrieval are further provided, for example, in FIG. 7A.

At 506, a build stage modification operation is performed. In the build stage modification operation, the computer system 202 modifies the first subset of instructions associated with the first build stage based on the second input. In case the computer system 202 receives the specific modified instructions in the second input, then the computer system 202 replaces the modified first subset of instructions with the specific modified instructions to ensure that the multi-stage container image 214C is debugged correctly. The specific modified instructions indicate the negative feedback and the computer system 202 trains the AI model 208 based on the negative feedback as discussed in the description of FIG. 4. In case the computer system 202 receives the message in the second input, the message indicates the positive feedback, and the computer system 202 trains the AI model 208 based on the positive feedback as discussed in the description of FIG. 4.

At 508, a container image generation operation is performed. In the container image generation operation, the computer system 202 generates the first portion of the multi-stage container image 214C based on the modified first subset of instructions. Details about the generation of the first portion of the multi-stage container image 214C are provided, for example, in FIG. 3.

FIG. 6 is a diagram that illustrates training of an artificial intelligence (AI) model for generation of multi-stage container images, in accordance with an embodiment of the disclosure. FIG. 6 is explained in conjunction with FIG. 1, FIG. 2, FIG. 3, FIG. 4, and FIG. 5. As shown, there is a training portion above line 600 and an implementation portion below line 600. With reference to FIG. 6, there is further shown the AI model 208. In the training portion above line 600, the computer system 202 retrieves historical data and a plurality of modified instructions from the one or more data sources 204 to generate a training dataset and for training 602 of the AI model 208 based on the training dataset.

At 604, a historical data retrieval operation is performed. In the historical data retrieval operation, the computer system 202 retrieves the historical data from the one or more data sources 204. The historical data includes a plurality of instructions and a set of errors associated with the plurality of instructions. The plurality of instructions includes the instructions for the generation of one or more historical multi-stage container images. The set of errors includes the errors identified during the execution of the plurality of instructions. The plurality of instructions is inclusive of the set of instructions and the set of errors is inclusive of the first set of errors and the second set of errors.

By way of example, and not by limitation, the historical data is represented in Table 3 below:

TABLE 3
Historical Data

| Instructions | Errors |
|---|---|
| FROM node: 14 | # Incorrect command to start the application |
| COPY./app | “RUN node start.js” change the command to |
| WORKDIR/app | CMD |
| RUN npm install | #(The original instruction “RUN node |
| RUN node start.js | start.js” is incorrect for starting the |
| | application because the RUN command is |
| | intended for executing commands during |
| | the image build process, rather than for |
| | running the application itself when the |
| | container is started) |
| FROM golang: 1.16 as builder | # Copy command missing before the |
| COPY./app | command “RUN./myapp” |
| RUN cd/app && go build -o myapp | #(The original file structure attempts to |
| FROM ubuntu | build an application using a multi-stage |
| RUN./myapp | build process but incorrectly tries to run the |
| | application directly in the image after the |
| | build stage. The command “RUN./myapp” |
| | in the second stage is problematic because it |
| | executes during the image build process |
| | rather than when the container is run, which |
| | means the application won't be running in |
| | the intended runtime environment) |
| FROM alpine: latest | # Change cd to WORKDIR for less |
| RUN apk add --no-cache git | execution time |
| RUN git clone <repository-url> | #(The original file structure uses a series of |
| RUN <cd repository && make> | RUN commands to clone a repository and |
| | build the application, but it relies on |
| | changing directories with “cd”, which can |
| | lead to confusion and potential errors in |
| | multi-layered Docker images.) |
| FROM node: 14 | # Environment Variable missing (declare |
| WORKDIR/app | environment variable for production mode) |
| COPY . . . | #(The original file structure contains a |
| RUN npm install CMD [“node”, “server.js”] | minor error in the way the commands are |
| | organized, specifically with the placement |
| | of the CMD instruction. In the first file, |
| | the CMD command is incorrectly placed on |
| | the same line as the RUN npm |
| | install command, which can lead to |
| | confusion and improper execution) |
| FROM alpine: latest | # Use COPY instead of ADD |
| ADD myapp.tar.gz/app/ | #(The original file uses the ADD instruction |
| | to unpack the tarball, which can lead to |
| | unintended behavior since ADD has |
| | additional functionalities, such as |
| | automatically extracting compressed files |
| | and supporting remote URLs. ADD can |
| | reduce clarity and predictability in the build |
| | process) |
| FROM alpine: latest as builder | # Syntax error in “RUN apk add --no-cache |
| RUN apk add --no-cache g++ | g++” |
| RUN make build | # Copy command missing before the |
| FROM ubuntu: 20.04 | command “RUN make install” |
| RUN make install | # Syntax error in “RUN <pip install |
| FROM ubuntu as builder | python>” |
| RUN make build | |
| RUN <pip install python> | |

At 606, a modified instructions retrieval operation is performed. In the modified instructions retrieval operations, the computer system 202 retrieves the plurality of modified instructions associated with the set of errors from the one or more data sources 204. Each modified instruction of the plurality of modified instruction is associated with the resolution of a respective error of the set of errors that were identified during the execution of the plurality of instructions for the generation of the one or more historical multi-stage container images. The plurality of modified instructions is inclusive of the modified first subset of instructions and the modified second subset of instructions.

By way of example, and not by limitation, the computer system 202 retrieves the plurality of modified instructions that can be represented in Table 4 below:

TABLE 4
Plurality of Modified Instructions

| Instructions | Modified Instructions |
|---|---|
| FROM node: 14 | FROM node: 14 |
| COPY./app | COPY./app |
| WORKDIR/app | WORKDIR/app |
| RUN npm install | RUN npm install |
| RUN node start.js | # Correct command to start the application |
| | CMD [“node”, “start.js”] |
| | #(The original instruction “RUN node start.js” |
| | is incorrect for starting the application because |
| | the RUN command is intended for executing |
| | commands during the image build process, |
| | rather than for running the application itself |
| | when the container is started. To resolve the |
| | issue, we should change the command to |
| | “CMD [“node”, “start.js”]”. The modification |
| | specifies the command that should be executed |
| | when the container is run, ensuring that the |
| | application starts correctly in its intended |
| | runtime environment. By using CMD, we allow |
| | the container to launch the application properly, |
| | enabling it to respond to requests and perform |
| | its designated functions once the container is |
| | instantiated.) |
| FROM golang: 1.16 as builder | FROM golang: 1.16 as builder |
| COPY./app | COPY./app |
| RUN cd/app && go build -o myapp | RUN cd/app && go build -o myapp |
| FROM ubuntu | FROM ubuntu |
| RUN./myapp | COPY --from = builder/app/myapp. # Copy |
| | the built app from the builder stage |
| | RUN./myapp |
| | #(The original file structure attempts to build |
| | an application using a multi-stage build process |
| | but incorrectly tries to run the application |
| | directly in the image after the build stage. The |
| | command “RUN./myapp” in the second stage |
| | is problematic because it executes during the |
| | image build process rather than when the |
| | container is run, which means the application |
| | won't be running in the intended runtime |
| | environment. By modifying the Dockerfile to |
| | include “COPY --from = builder/app/myapp.” |
| | before the RUN command, we ensure that the |
| | compiled binary “myapp” is copied from the |
| | builder stage into the image. However, to |
| | properly execute the application when the |
| | container starts, we should replace the RUN |
| | command with “CMD [“./myapp”]”. The |
| | change allows the application to run in the |
| | correct context when the container is launched, |
| | ensuring that it operates as intended and can |
| | respond to any incoming requests or perform |
| | its designated tasks effectively. The |
| | modification enhances the overall functionality |
| | and usability of the image) |
| FROM alpine: latest | FROM alpine: latest |
| RUN apk add --no-cache git | RUN apk add --no-cache git |
| RUN git clone <repository-url> | RUN git clone <repository-url> |
| RUN <cd repository && make> | WORKDIR repository |
| | RUN make |
| | # Changed cd to WORKDIR for better practice |
| | #(The original file structure uses a series of |
| | RUN commands to clone a repository and build |
| | the application, but it relies on changing |
| | directories with “cd”, which can lead to |
| | confusion and potential errors in multi-layered |
| | Docker images. By modifying the file to |
| | include “WORKDIR repository” after cloning |
| | the repository, we establish a dedicated |
| | working directory for subsequent commands. |
| | The change enhances clarity and |
| | maintainability, as all following commands will |
| | be executed within the specified directory |
| | without needing to use “cd”. Consequently, the |
| | command “RUN make” will now correctly |
| | execute within the context of the cloned |
| | repository, ensuring that the build process runs |
| | smoothly. The approach not only adheres to |
| | best practices by improving readability and |
| | reducing the risk of errors but also simplifies |
| | the file structure, making it easier for |
| | developers to understand and modify in the |
| | future) |
| FROM node: 14 | FROM node: 14 |
| WORKDIR/app | WORKDIR/app |
| COPY . . . | COPY . . . |
| RUN npm install CMD [“node”, | ENV NODE_ENV = production # Declare |
| “server.js”] | environment variable for production mode |
| | RUN npm install --only = prod # Install only |
| | production dependencies |
| | CMD [“node”, “server.js”] |
| | #(The original file structure contains a minor |
| | error in the way the commands are organized, |
| | specifically with the placement of |
| | the CMD instruction. In the first file, |
| | the CMD command is incorrectly placed on the |
| | same line as the RUN npm install command, |
| | which can lead to confusion and improper |
| | execution. By modifying the file to separate |
| | these commands and correctly place CMD |
| | [“node”, “server.js”] on its own line, we clarify |
| | the intent that the command should be executed |
| | when the container starts, rather than during the |
| | build process) |
| FROM alpine: latest | FROM alpine: latest |
| ADD myapp.tar.gz/app/ | COPY myapp.tar.gz/app/ # Use COPY for |
| | simple file copying |
| | RUN tar -xzf/app/myapp.tar.gz -C/app/ # |
| | Extract the application |
| | #(The original file uses the ADD instruction to |
| | unpack the tarball, which can lead to |
| | unintended behavior since ADD has additional |
| | functionalities, such as automatically extracting |
| | compressed files and supporting remote URLs. |
| | While the may seem convenient, it can reduce |
| | clarity and predictability in the build process. |
| | By modifying the file to use COPY |
| | myapp.tar.gz/app/ instead, we explicitly |
| | indicate that we are simply copying the tarball |
| | into the /app/directory without any additional |
| | processing. Following, the instruction RUN |
| | tar -xzf/app/myapp.tar.gz -C/app/ is added to |
| | extract the contents of the tarball. The |
| | separation of concerns enhances the clarity of |
| | the file, making it clear that the copying and |
| | extraction processes are distinct steps. The |
| | approach not only adheres to best practices by |
| | using COPY for straightforward file transfers |
| | but also ensures that the build process is more |
| | predictable and easier to understand, ultimately |
| | leading to a more maintainable file) |
| FROM alpine: latest as builder | FROM alpine: latest as builder |
| RUN apk add --no-cache g++ | RUN apk add --no-cache gcc g++ # correct |
| RUN make build | syntax |
| FROM ubuntu: 20.04 | RUN make build |
| RUN make install | FROM ubuntu: 20.04 |
| | COPY --from = builder/path/to/built/files/ |
| | desired/path # Copy built files from builder |
| | stage |
| | RUN make install |
| | #(The original file structure attempts to build |
| | an application using a multi-stage build process |
| | but lacks clarity and correctness in its |
| | execution. In the first version, the RUN make |
| | install command in the second stage is |
| | problematic because it assumes that the critical |
| | built files are already present in the Ubuntu |
| | image, which is not the case. Additionally, the |
| | first stage does not specify the required |
| | compiler, which could lead to build failures. |
| | In the modified file, the first stage is improved |
| | by explicitly installing both gcc and g++ with |
| | the command RUN apk add --no-cache gcc |
| | g++, ensuring that the critical compilers are |
| | available for building the application. The |
| | correction addresses potential compilation |
| | issues that may arise from missing |
| | dependencies. Furthermore, the use of COPY -- |
| | from = builder/path/to/built/files/ |
| | desired/path in the second stage effectively |
| | transfers the built files from the builder stage to |
| | the Ubuntu image, ensuring that the installation |
| | process has access to the critical artifacts. The |
| | structured approach not only clarifies the build |
| | process but also enhances the reliability of the |
| | final image by ensuring that all required |
| | components are present and correctly |
| | configured for installation. Overall, these |
| | changes lead to a more robust and maintainable |
| | file that adheres to best practices in multi-stage |
| | builds) |
| FROM ubuntu as builder | FROM ubuntu as builder |
| RUN make build | RUN make build |
| RUN <pip install python> | RUN <pip install gcc python> # correct syntax |

At 608, a training dataset generation operation is performed. In the training dataset generation operation, the computer system 202 generates the training dataset for the training 602 of the AI model 208 based on the plurality of instructions, the set of errors, and the plurality of modified instructions. The training dataset includes a set of inputs (the plurality of instructions), a first set of outputs (the set of errors), and a second set of outputs (the plurality of modified instructions). By way of example, and not by limitation, the computer system 202 generates the training dataset provided in Table 5 below:

TABLE 5
Training Dataset

| Input | First Output | Second Output |
|---|---|---|
| (Instructions) | (Errors) | (Modified Instructions) |
| FROM node: 14 | # Incorrect command to start | FROM node: 14 |
| COPY./app | the application “RUN node | COPY./app |
| WORKDIR/app | start.js” change it to CMD | WORKDIR/app |
| RUN npm install | | RUN npm install |
| RUN node start.js | | # Correct command to |
| | | start the application |
| | | CMD [“node”, “start.js”] |
| FROM golang: 1.16 as builder | # Copy command missing | FROM golang: 1.16 as |
| COPY./app | before the command | builder |
| RUN cd/app && go build -o | “RUN./myapp” | COPY./app |
| myapp | | RUN cd/app && go |
| FROM ubuntu | | build -o myapp |
| RUN./myapp | | FROM ubuntu |
| | | COPY --from = builder/ |
| | | app/myapp. # Copy the |
| | | built app from the builder |
| | | stage |
| | | RUN./myapp |
| FROM alpine: latest | # Change cd to WORKDIR | FROM alpine: latest |
| RUN apk add --no-cache git | for less execution time | RUN apk add --no-cache |
| RUN git clone <repository- | | git |
| url> | | RUN git clone |
| RUN <cd repository && | | <repository-url> |
| make> | | WORKDIR repository |
| | | RUN make |
| | | # Changed cd to |
| | | WORKDIR for better |
| | | practice |
| FROM node: 14 | # Environment Variable | FROM node: 14 |
| WORKDIR/app | missing (declare environment | WORKDIR/app |
| COPY . . . | variable for production mode) | COPY . . . |
| RUN npm install CMD | | ENV |
| [“node”, “server.js”] | | NODE_ENV = production |
| | | # Declare environment |
| | | variable for production |
| | | mode |
| | | RUN npm install -- |
| | | only = prod # Install only |
| | | production dependencies |
| | | CMD [“node”, “server.js”] |
| FROM alpine: latest | # Use COPY instead of ADD | FROM alpine: latest |
| ADD myapp.tar.gz/app/ | | COPY myapp.tar.gz/app/ |
| | | # Use COPY for simple |
| | | file copying |
| | | RUN tar -xzf/ |
| | | app/myapp.tar.gz -C/app/ |
| | | # Extract the application |
| FROM alpine: latest as builder | # Syntax error in “RUN apk | FROM alpine: latest as |
| RUN apk add --no-cache g++ | add --no-cache g++” | builder |
| RUN make build | # Copy command missing | RUN apk add --no-cache |
| FROM ubuntu: 20.04 | before the command “RUN | gcc g++ # correct syntax |
| RUN make install | make install” | RUN make build |
| | | FROM ubuntu: 20.04 |
| | | COPY --from = builder/ |
| | | path/to/built/files/ |
| | | desired/path # Copy built |
| | | files from builder stage |
| | | RUN make install |
| FROM ubuntu as builder | # Syntax error in “RUN <pip | FROM ubuntu as builder |
| RUN make build | install python>” | RUN make build |
| RUN <pip install python> | | RUN <pip install gcc |
| | | python> # correct syntax |

At 610, an AI model training operation is performed. In the AI model training operation, the computer system 202 trains the AI model 208 based on the training dataset. Specifically, the computer system 202 provides the AI model 208 with the set of inputs (the plurality of instructions) from the training dataset. The AI model 208 analyzes the set of inputs (the plurality of instructions), determines a first machine learning algorithm for the prediction of the first output (the set of errors) using the input (the plurality of instructions), and estimates the values of the weights and the hyperparameters. The AI model 208 further utilizes the determined first machine learning algorithm in the implementation portion below line 600 to determine the first set of errors associated with the first subset of instructions based on the first subset of instructions.

In the training 602 of the AI model 208, the computer system 202 further adjusts the values of weights and the hyperparameters based on a determination that the predicted first output (predicted error) does not match the actual first output (the actual error) in the training dataset. The computer system 202 further repeats the adjustment of the values of the weights and the hyperparameters until the minima of the loss function is achieved or the training error is minimized.

Similarly, the computer system 202 trains the AI model 208 for the prediction of the modified instructions. The computer system 202 provides the AI model 208 with the set of inputs (the plurality of instructions) and the first set of outputs (the set of errors). The AI model 208 analyzes the plurality of instructions and the set of errors and determines a second machine learning algorithm for the prediction of the second output (the plurality of modified instructions) using the input (the plurality of instructions) and the first output (the set of errors) and estimates the values of the weights and the hyperparameters. The AI model 208 further utilizes the determined second machine learning algorithm in the implementation portion below line 600 to resolve the first set of errors by generating the modified first subset of instructions based on the first set of errors and the first subset of instructions.

In the training 602 of the AI model 208, the computer system 202 further adjusts the values of weights and the hyperparameters based on a determination that the predicted first output (predicted modified instruction) does not match the actual second output (the actual modified instruction) in the training dataset. The computer system 202 further repeats the adjustment of the values of the weights and the hyperparameters until the minima of the loss function is achieved or the training error is minimized.

In the implementation portion below line 600, a set of instructions 612 is retrieved. The set of instructions 612 is associated with the generation of the multi-stage container image 214C. In an embodiment of the disclosure, the computer system 202 utilizes each instruction of the set of instructions 612 to generate the multi-stage container image 214C of the application 214A. Examples of each instruction of the set of instructions 612 include at least one of but are not limited to, a “RUN” instruction, an “ADD” instruction, a “FROM” instruction, a “COPY” instruction, a “CMD” instruction, an “ENTRYPOINT” instruction, or the like. By way of example, and not by limitation, the computer system 202 retrieves the set of instructions 612 given below:
FROM node:14
COPY./app
WORKDIR/app
RUN npm install
RUN node start.js

At 614, an AI model application operation is performed. In the AI model application operation, the computer system 202 applies the trained AI model 208 to the set of instructions 612. The AI model 208 analyzes the patterns and the relationships within the set of instructions 612 based on its training dataset and then determines one or more errors associated with the set of instructions using the determined first machine learning algorithm. In an embodiment, the AI model 208 determines a similarity score (on a scale of 0-1) of the set of instructions with each instruction of the plurality of instructions (from the training dataset). The similarity score is a quantitative measure that indicates how closely two sets of instructions, texts, or data points resemble each other. The AI model 208 further determines the one or more errors from the set of errors based on the similarity score of the set of instructions with a corresponding instruction of the plurality of instructions. For example, the set of instructions “COPY./app, WORKDIR/app, RUN npm install, RUN node start.js” have the similarity score of 0.8 with a first instruction “FROM node:14, COPY./app, WORKDIR/app, RUN npm install, RUN node start.js” in the training dataset. But the set of instructions have a similarity score of 0.2 with a second instruction “RUN <pip install python>” of the training dataset. Hence, the AI model 208 determines the one or more errors in the set of instructions as “Incorrect command to start the application “RUN node start.js” change it to CMD” since the first instruction has a greater similarly score to the set of instructions as compared to the second instruction and the first instruction was associated with the error “Incorrect command to start the application “RUN node start.js” change it to CMD” in the training dataset. Details about the error identification operation are provided, for example, in FIG. 3 and FIG. 4. As defined above, the set of errors includes actual runtime errors and compile time errors (that include syntax errors and semantic errors) that prevent the application 214A from executing correctly. The set of errors is further associated with inefficiencies or complexities that are associated with excessive resource usage, redundant complexities, redundant dependencies, and memory leaks.

At 616, an errors identification operation is performed. In the errors identification operation, the computer system 202 identifies the one or more errors associated with the set of instructions 612 based on the application of the AI model 208 to the set of instructions 612. By way of example, and not by limitation, the computer system 202 identifies the one or more errors in the set of instructions 612 as “Incorrect command to start the application “RUN node start.js” change it to CMD”. Details about the error identification operation are provided, for example, in FIG. 3 and FIG. 4.

At 618, an errors resolution operation is performed. In the errors resolution operation, the computer system 202 resolves the one or more errors. Specifically, the computer system 202 applies the trained AI model 208 to the one or more errors and resolves the one or more errors based on the application of the trained AI model 208 to the one or more errors. The computer system 202 generates a modified set of instructions based on the application of trained AI model 208 to the one or more errors. Each instruction of the modified set of instructions is associated with a resolution of the respective error of the one or more errors. The computer system 202 further executes the modified set of instructions to generate the multi-stage container image 214C. Details about the error resolution operation are provided, for example, in FIG. 3 and FIG. 4.

By way of example, and not by limitation, the modified set of instructions is given below:
FROM node: 14
COPY./app
WORKDIR/app
RUN npm install
CMD [“node”, “start.js”]

In this scenario, the original instruction “RUN node start.js” was incorrect for starting the application because the RUN command is intended for executing commands during the image build process, rather than for running the application itself when the container is started. To resolve the issue, the computer system 202 changed the command to “CMD [“node”, “start.js”]”. The modification specifies the command that should be executed when the container is run, ensuring that the application starts correctly in its intended runtime environment.

FIG. 7A is a diagram that illustrates an exemplary first user interface for generation of a multi-stage container image using artificial intelligence (AI), in accordance with an embodiment of the disclosure. FIG. 7A is explained in conjunction with elements from FIG. 1, FIG. 2, FIG. 3, FIG. 4, FIG. 5, and FIG. 6. With reference to FIG. 7A, there is shown an exemplary diagram 700A that includes a user device 702 and an input page 704. The input page 704 includes a first user interface (UI) element 706, a second UI element 708A, a third UI element 708B, and a fourth UI element 710. The user device 702 is an exemplary embodiment of the user device 212 of FIG. 2.

With reference to FIG. 7A, the computer system 202 renders the input page 704 on the user interface (UI) of the user device 702. The input page 704 corresponds to a web page or online form that is designed to collect information from the user 216 for debugging of the container image 214C of the application 214A. In an embodiment of the disclosure, the input page 704 is used to gather relevant details from the user to resolve the errors associated with the generation of the multi-stage container image 214C.

The first UI element 706 corresponds to a table. The first UI element is used to provide information to the user 216 about the identified errors and the resolution of the identified errors (the modified instructions). First column of the table provides the information about the identified errors (e.g. RUN <pip install python>). Second column of the table provides the information about the resolution of the errors or the modified instructions (e.g. RUN <pip install gcc python>).

The second UI element 708A corresponds to a button labeled “Proceed with the Suggestion”. Upon selecting the second UI element 708A the computer system 202 receives a message “proceed with the suggestion” that indicates the positive feedback as discussed in the description of FIG. 5. The third UI element 708B corresponds to a textbox labeled “Enter collection manually”. The third UI element 708B is used to obtain the modified instruction from the user device 212 in case the predicted modified instruction is inaccurate. Details about the modified instruction retrieval are provided, for example, in FIG. 5. The fourth UI element 710 corresponds to a button labeled “Submit”. Upon selecting the fourth UI element 710, the computer system 202 receives the input information (the modified instruction or the message) and further initiates the generation of the multi-stage container image 214C. Details about the container image generation operation are provided, for example, in FIG. 3 and FIG. 4.

FIG. 7B is a diagram that illustrates an exemplary second user interface for generation of a multi-stage container image using artificial intelligence (AI), in accordance with an embodiment of the disclosure. FIG. 7B is explained in conjunction with elements from FIG. 1, FIG. 2, FIG. 3, FIG. 4, FIG. 5, FIG. 6, and FIG. 7A. With reference to FIG. 7B, there is shown an exemplary diagram 700B that includes the user device 702 and an output page 712. The output page 712 includes a fifth UI element 714 and a sixth UI element 716. The user device 702 is an exemplary embodiment of the user device 212 of FIG. 2.

With reference to FIG. 7B, the computer system 202 renders the output page 712 on the display unit (or the user interface) of the user device 702. The computer system 202 renders the message on the user device 702 that indicates the generation of the multi-stage container image 214C. The fifth UI element 714 corresponds to a textbox that includes the message, for example, “Notification: The Container Image of the Application has been successfully generated”. The sixth UI element 716 corresponds to a button labeled “Back”. Upon Selecting the sixth UI element 716, the computer system 202 renders the input page 704 on the user device 702.

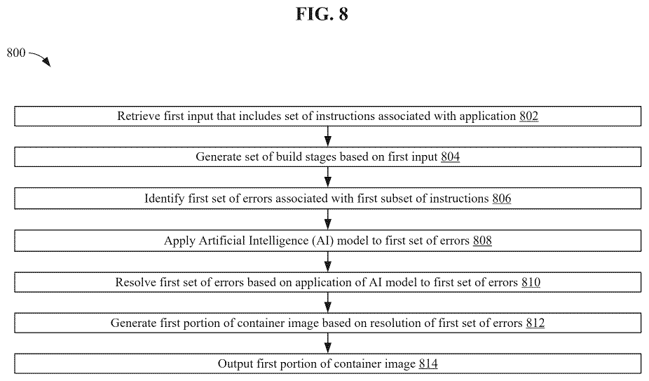

FIG. 8 is a diagram that illustrates a flowchart of a first exemplary method for generation of a multi-stage container image using artificial intelligence (AI), in accordance with an embodiment of the disclosure. FIG. 8 is explained in conjunction with elements from FIG. 1, FIG. 2, FIG. 3, FIG. 4, FIG. 5, FIG. 6, FIG. 7A, and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the first input 214B that includes the set of instructions associated with the application 214A is retrieved. In an embodiment of the disclosure, the computer system 202 retrieves the first input 214B that includes the set of instructions associated with the application 214A. Details about the first input retrieval operation are provided, for example, in FIG. 2 and FIG. 3.

At 804, the set of build stages is generated based on the first input 214B. Each build stage of the set of build stages includes the corresponding subset of instructions of the set of instructions. In an embodiment of the disclosure, the computer system 202 generates the set of build stages based on the first input 214B. Each build stage of the set of build stages includes the corresponding subset of instructions of the set of instructions. Details about the build stages generation operation are provided, for example, in FIG. 2 and FIG. 3.

At 806, the first set of errors associated with the first subset of instructions of the set of instructions are identified. The first subset of instructions is associated with the first build stage of the set of build stages. In an embodiment of the disclosure, the computer system 202 identifies the first set of errors associated with the first subset of instructions of the set of instructions. The first subset of instructions is associated with the first build stage of the set of build stages. Details about the first errors identification operation are provided, for example, in FIG. 2 and FIG. 3.

At 808, the AI model 208 is applied to the first set of errors associated with the first build stage. In an embodiment of the disclosure, the computer system 202 applies the AI model 208 to the first set of errors associated with the first build stage. Details about the first AI model application operation are provided, for example, in FIG. 2, FIG. 3, and FIG. 6.

At 810, the first set of errors is resolved based on the application of the AI model 208 to the first set of errors. In an embodiment of the disclosure, the computer system 202 resolves the first set of errors based on the application of the AI model 208 to the first set of errors. Details about the first errors resolution operation are provided, for example, in FIG. 2 and FIG. 3.

At 812, the first portion of the multi-stage container image 214C is generated based on the resolution of the first set of errors. In an embodiment of the disclosure, the computer system 202 generates the first portion of the multi-stage container image 214C based on the resolution of the first set of errors. Details about the first portion generation operation are provided, for example, in FIG. 2 and FIG. 3.

At 814, the first portion of the multi-stage container image 214C is outputted. In an embodiment of the disclosure, the computer system 202 outputs the first portion of the multi-stage container image 214C. Details about the first portion output operation are provided, for example, in FIG. 2 and FIG. 3.

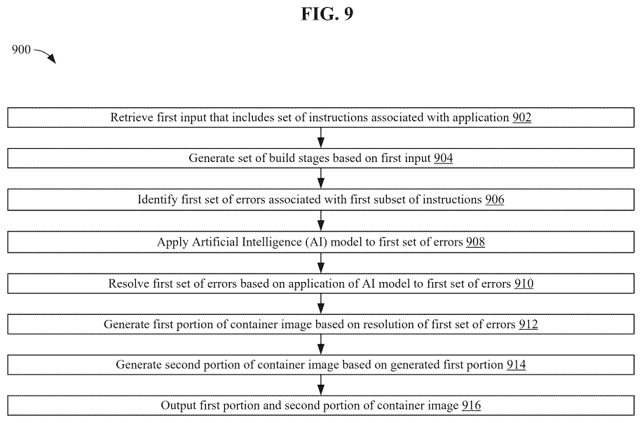

FIG. 9 is a diagram that illustrates a flowchart of a second exemplary method for generation of a multi-stage container image using artificial intelligence (AI), in accordance with an embodiment of the disclosure. FIG. 9 is explained in conjunction with elements from FIG. 1, FIG. 2, FIG. 3, FIG. 4, FIG. 5, FIG. 6, FIG. 7A, FIG. 7B, and FIG. 8. With reference to FIG. 9, there is shown a flowchart 900. The operations of the exemplary method may be executed by any computing system, for example, by the computer 102 of FIG. 1 or the computer system 202 of FIG. 2. The operations of the flowchart 900 may start at 902.

At 902, the first input 214B that includes the set of instructions associated with the application 214A is retrieved. In an embodiment of the disclosure, the computer system 202 retrieves the first input 214B that includes the set of instructions associated with the application 214A. Details about the first input retrieval operation are provided, for example, in FIG. 2 and FIG. 3.

At 904, the set of build stages is generated based on the first input 214B. Each build stage of the set of build stages includes the corresponding subset of instructions of the set of instructions. In an embodiment of the disclosure, the computer system 202 generates the set of build stages based on the first input 214B. Each build stage of the set of build stages includes the corresponding subset of instructions of the set of instructions. Details about the build stages generation operation are provided, for example, in FIG. 2 and FIG. 3.

At 906, the first set of errors associated with the first subset of instructions of the set of instructions are identified. The first subset of instructions is associated with the first build stage of the set of build stages. In an embodiment of the disclosure, the computer system 202 identifies the first set of errors associated with the first subset of instructions of the set of instructions. The first subset of instructions is associated with the first build stage of the set of build stages. Details about the first errors identification operation are provided, for example, in FIG. 2 and FIG. 3.

At 908, the AI model 208 is applied to the first set of errors associated with the first build stage. In an embodiment of the disclosure, the computer system 202 the computer system 202 applies the AI model 208 to the first set of errors associated with the first build stage. Details about the first AI model application operation are provided, for example, in FIG. 2, FIG. 3, and FIG. 6.

At 910, the first set of errors is resolved based on the application of the AI model 208 to the first set of errors. In an embodiment of the disclosure, the computer system 202 resolves the first set of errors based on the application of the AI model 208 to the first set of errors. Details about the first errors resolution operation are provided, for example, in FIG. 2 and FIG. 3.

At 912, the first portion of the multi-stage container image 214C is generated based on the resolution of the first set of errors. In an embodiment of the disclosure, the computer system 202 generates the first portion of the multi-stage container image 214C based on the resolution of the first set of errors. Details about the first portion generation operation are provided, for example, in FIG. 2 and FIG. 3.

At 914, the second portion of the multi-stage container image 214C is generated based on the generated first portion. In an embodiment of the disclosure, the computer system 202 generates the second portion of the multi-stage container image 214C based on the generated first portion. Details about the second portion generation operation are provided, for example, in FIG. 4.

At 916, the first portion and the second portion of the multi-stage container image 214C are outputted. In an embodiment of the disclosure, the computer system 202 outputs the first portion and the second portion of the multi-stage container image 214C. Details about the first portion and the second portion output operation are provided, for example, in FIG. 2, FIG. 3, and FIG. 4.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
retrieving, by a computer, a first input comprising a set of instructions associated with an application;
generating, by the computer, a set of build stages based on the first input, wherein each build stage of the set of build stages comprises a corresponding subset of instructions of the set of instructions;
identifying, by the computer, a first set of errors associated with a first subset of instructions of the set of instructions, wherein the first subset of instructions is associated with a first build stage of the set of build stages;
applying, by the computer, an Artificial Intelligence (AI) model to the first set of errors;
resolving, by the computer, the first set of errors based on the application of the AI model to the first set of errors;
generating, by the computer, a first portion of a container image based on the resolution of the first set of errors; and
outputting, by the computer, the first portion of the container image.

2. The computer-implemented method of claim 1, further comprising:
executing, by the computer, a second subset of instructions of the set of instructions based on the generated first portion, wherein the second subset of instructions is associated with a second build stage of the set of build stages;
generating, by the computer, a second portion of the container image based on the execution of the second subset of instructions; and
outputting, by the computer, the second portion of the container image.

3. The computer-implemented method of claim 2, further comprising:
identifying, by the computer, a second set of errors associated with the second subset of instructions;
applying, by the computer, the AI model to the second set of errors;
resolving, by the computer, the second set of errors based on the application of the AI model to the second set of errors; and
generating, by the computer, the second portion of the container image based on the resolution of the second set of errors and the generated first portion.

4. The computer-implemented method of claim 3, further comprising:
generating, by the computer, the container image based on the generated first portion and the generated second portion; and
outputting, by the computer, the container image.

5. The computer-implemented method of claim 4, further comprising:
modifying, by the computer, the first subset of instructions associated with the first build stage based on the resolution of the first set of errors;
executing, by the computer, the modified first subset of instructions; and
generating, by the computer, the first portion based on the execution of the modified first subset of instructions.

6. The computer-implemented method of claim 5, further comprising:
retrieving, by the computer, a second input associated with the first set of errors; and
modifying, by the computer, the first subset of instructions based on the second input.

7. The computer-implemented method of claim 6, further comprising:
rendering, by the computer, the first set of errors and the modified first subset of instructions on a user device; and
retrieving, by the computer, the second input from the user device.

8. The computer-implemented method of claim 5, further comprising:
retrieving, by the computer, historical data comprising a plurality of instructions and a set of errors associated with the plurality of instructions, wherein the plurality of instructions is inclusive of the set of instructions and the set of errors is inclusive of the first set of errors and the second set of errors;
retrieving, by the computer, a plurality of modified instructions associated with the set of errors, wherein each modified instruction of the plurality of modified instructions is associated with a resolution of a respective error of the set of errors, and wherein the plurality of modified instructions is inclusive of the modified first subset of instructions;
generating, by the computer, a training dataset based on the plurality of instructions, the set of errors, and the plurality of modified instructions; and
training, by the computer, the AI model based on the training dataset.

9. The computer-implemented method of claim 1, further comprising:
generating, by the computer, one or more breakpoints in the first subset of instructions; and
resolving, by the computer, the first set of errors based on the generated one or more breakpoints.

10. The computer-implemented method of claim 1, further comprising:
applying, by the computer, the AI model to the first subset of instructions associated with the first build stage; and
identifying, by the computer, the first set of errors associated with the first build stage based on the application of the AI model to the first subset of instructions.

11. The computer-implemented method of claim 1, further comprising:
applying, by the computer, one or more rules to the first input; and
generating, by the computer, the set of build stages based on the application of the one or more rules to the first input.

12. The computer-implemented method of claim 1, further comprising:
receiving, by the computer, feedback associated with the generated first portion of the container image; and
training, by the computer, the AI model based on the feedback.

13. A computer system, comprising:
a processor set;
one or more computer-readable storage media; and
program instructions stored on the one or more computer-readable storage media, the program instructions executable by the processor set to cause the processor set to:
retrieve a first input that comprises a set of instructions associated with an application;
generate a set of build stages based on the first input, wherein each build stage of the set of build stages comprises a corresponding subset of instructions of the set of instructions;
identify a first set of errors associated with a first subset of instructions of the set of instructions, wherein the first subset of instructions is associated with a first build stage of the set of build stages;
apply an Artificial Intelligence (AI) model to the first set of errors;
resolve the first set of errors based on the application of the AI model to the first set of errors;
generate a first portion of a container image based on the resolution of the first set of errors;
generate a second portion of the container image based on the generated first portion; and
output the first portion and the second portion of the container image.

14. The computer system of claim 13, wherein the program instructions further cause the processor set to:
execute a second subset of instructions of the set of instructions based on the generated first portion, wherein the second subset of instructions is associated with a second build stage of the set of build stages; and
generate the second portion of the container image based on the execution of the second subset of instructions.

15. The computer system of claim 14, wherein the program instructions further cause the processor set to:
identify a second set of errors associated with the second subset of instructions;
apply the AI model to the second set of errors;
resolve the second set of errors based on the application of the AI model to the second set of errors; and
generate the second portion of the container image based on the resolution of the second set of errors and the generated first portion.

16. The computer system of claim 15, wherein the program instructions further cause the processor set to:
generate the container image based on the generated first portion and the generated second portion; and
output the container image.

17. The computer system of claim 13, wherein the program instructions further cause the processor set to:
modify the first subset of instructions associated with the first build stage based on the resolution of the first set of errors;
execute the modified first subset of instructions; and
generate the first portion based on the execution of the modified first subset of instructions.

18. The computer system of claim 13, wherein the program instructions further cause the processor set to:
generate one or more breakpoints in the first subset of instructions; and
resolve the first set of errors based on the generated one or more breakpoints.

19. The computer system of claim 13, wherein the program instructions further cause the processor set to:
apply the AI model to the first subset of instructions associated with the first build stage; and
identify the first set of errors associated with the first build stage based on the application of the AI model to the first subset of instructions.

20. A computer-program product for generation of a container image, the computer-program product comprising:
one or more computer-readable storage media; and
program instructions stored on the one or more computer-readable storage media to perform operations comprising:
retrieving a first input that comprises a set of instructions associated with an application;
generating a set of build stages based on the first input, wherein each build stage of the set of build stages comprises a corresponding subset of instructions of the set of instructions;
identifying a first set of errors associated with a first subset of instructions of the set of instructions, wherein the first subset of instructions is associated with a first build stage of the set of build stages;
applying an Artificial Intelligence (AI) model to the first set of errors;
resolving the first set of errors based on the application of the AI model to the first set of errors;
generating a first portion of the container image based on the resolution of the first set of errors; and
outputting the first portion of the container image.
